(19) United States
(12) Patent Application Publication
(10) Pub. No.: US 2004/0082312 A1
(43) Pub. Date: Apr. 29, 2004

(54) Communications network

(76) Inventors: Alan W O'Neill, Henley Beach (AU); Mathew S Corson, Chatham, NJ (US)

Correspondence Address: Nixon & Vanderhye, 8th Floor, 1100 North Glebe Road, Arlington, VA, 22201-4714, US

(21) Appl. No.: 10/468,351

(22) PCT Filed: Feb. 19, 2002
(86) PCT No.: PCT/GB02/00722

(30) Foreign Application Priority Data
Feb. 19, 2001 (EP) 01301453.5

(51) Int. Cl. H04M 1/66; H04M 11/00; H04M 3/16

(52) U.S. Cl. 455/405; 455/410; 455/406; 455/407; 455/409

(57) ABSTRACT

The present invention provides a method of, computer programs for and apparatus adapted to operate a communications network to determine membership of a group of access nodes of the communications network with which there is a relatively high probability that a mobile node will be associated after the mobile node has been associated with a first access node, access nodes being linked to other access nodes via data communications links, the method comprising:

a) detecting characteristics of relationships between access nodes;

b) operating the communications network to determine membership of the group in dependence on the detected characteristics.

The present invention relates to determining membership of groups of access nodes in a communications network. It has particular utility in the setting up of paging areas in a cellular mobile communications network.

In order to establish and maintain communication with a mobile device (mobile) via a cellular network, it is necessary to know which cell the mobile is in. This data (or a pointer to it) needs to be stored at a location store in or accessible to the cellular network. The location store must itself be at a known location.

The earliest mobiles sent location updates to the location store whenever they were switched on and moved between cells. The location updates were sent to and stored at the location store. The frequent sending of these location updates drained the battery of the mobile and used the resources of the cellular network.

Whilst a communication is taking place with a mobile, location updates are required if signals intended for the mobile are to be routed directly to the cell which is currently serving the mobile. As the mobile moves between cells, the incoming signals must be diverted to the new cell. This process is known as ‘handover’.

An alternative to sending updates on every cell change would be to copy the incoming signals to a plurality of cells around the mobile, but although this might reduce the number of location updates that need to be sent and handovers that need to be carried out, it undesirably increases the load on the network. A proposal along these lines is seen in Ghai et al's ‘A Protocol for Seamless Communications in a Picocellular Network’, International Conference on Communications, 1-5 May 1994, IEEE vol 1 pp 192-196.

Operators of conventional cellular networks alleviate the above problem by entering configuration data into the base station of each cell which groups contiguous cells into paging areas. Mobiles which have been inactive for a given period of time are required to send a location update only when they move between paging areas. In this scheme, in order to establish communication, a paging signal is broadcast across the paging area in which the mobile is located. The mobile replies to the paging message by indicating to the location store which cell it is currently in. The mobile then sends location updates on every cell change until the call is finished. A mobile that has not been active for a while and which only sends location updates on moving between paging areas is said to be in a ‘standby’ state.

One type of network configuration arranges the nodes of a network into a hierarchy, with the lower levels of the hierarchy being divided into smaller paging areas. An example is seen in EP 0 835 034. Such schemes allow paging at a selected level of coverage. However, it appears that data defining the hierarchy must be entered manually.

Conventional location areas are pre-configured by the network provider and are static, rigid and non-overlapping. Such location areas lead to the so-called ‘knife-edge’ problem when mobiles are frequently found at the edge of non-overlapping paging areas leading to frequent moves between paging areas and an inefficient number of location updates.

The concept of partially overlapping location areas was proposed by Gu and Rappaport in ‘Mobile User Registration in Cellular Systems with Overlapping Location Areas’ in 1999 IEEE 49^{th} Vehicular Technology Conference, 16-20 May 1999, IEEE volume 1 pp 802-806 and also by Varsamopoulos and Gupta in ‘On Dynamically Adapting Registration Areas to User Mobility Patterns in PCS Networks’ in Proceedings of the 1999 ICPP Workshops, 21-24 Sep. 1999, IEEE pp 108-113.

Most conventional cellular networks are circuit-switched, however much of the above development of paging is mirrored in packet-switched networks. Here also, the initial proposals (Mobile-IP) required a location update to be sent on every cell change. More recently, proposals for incorporating paging into IP networks have been put forward (the IETF have proposed some extensions to the MIP architecture known as the Minimal Paging Extensions for MIP (P-MIP)). An Internet draft describing these proposals is available at the IETF website referenced as draft-zhang-pmip-00.txt. Castelluccia suggests a more advanced solution in ‘Extending Mobile IP with Adaptive Individual Paging: A Performance Analysis’ in Proceedings of 5^{th} IEEE Symposium on Computer and Communications, 3-6 Jul. 2000, IEEE Comput. Soc pp 113-118. The configuration of paging areas described there is adaptive in the sense that paging areas adapt dynamically to a mobile's changing mobility parameters and individual in the sense that each mobile computes its own optimal paging area size.

IP networks use dynamic routing protocols which allow the network to re-route around failures quickly. Routing updates are sent to every node in an IP domain. This means that the signalling load placed on the network by mobile nodes is greater than that seen in circuit-switched networks. Several new routing protocols have been put forward to reduce the number of updates that follow the movement of a mobile from one access router to another—namely, Cellular IP, HAWAII, and Edge Mobility Architecture (EMA). Internet drafts are available at as follows: draft-ietf-mobileip-cellularip-00.txt, draft-ietf-mobileip-hawaii-01.txt, and draft-oneill-ema-02.txt. The addition of paging to these networks has also been suggested.

In the case of the HAWAII protocol, these extensions are set out in an Internet draft available at the IETF website identified as draft-ietf-mobileip-paging-hawaii-01.txt. That drafts suggests that paging areas may be configured in a dynamic fashion. However, no specific approaches to statically or dynamically defining paging areas are suggested.

In networks which can rapidly change their topology (such as IP networks), a more flexible approach to defining paging areas is required.

According to a first aspect of the present invention there is provided a method of operating a communications network to determine membership of a group of access nodes of the communications network with which there is a relatively high probability that a mobile node will be associated after the mobile node has been associated with a first access node, access nodes being linked to other access nodes via data communications links, the method comprising:

a) detecting characteristics of relationships between access nodes;

b) operating said communications network to determine membership of the group in dependence on the detected characteristics.

The present invention may be implemented in order to provide a communications network in which groups form location areas which may be used for location monitoring, paging or broadcasting areas and which are self-configuring.

According to one preferred embodiment, the detecting involves the first access node receiving one or more messages, the messages identifying one or more of the other access nodes. It is to be noted that the term ‘message’ could refer to a single packet. One advantage of the preferred embodiment is that the signalling that is required may be localised to the area of the first access nodes.

In one embodiment, the communications network is arranged so that other access nodes within a predetermined number of direct communications links of the first access node are selected for group membership. Preferably, the predetermined number may vary in dependence on a parameter or the identity of the first access node. One advantage of this embodiment is that the size and coverage of groups may be tuned to the particular characteristics of the first access node or the geographic region of coverage of the first access node, thus there may be a higher probability that a mobile node will be subsequently accessible at an access node of a group defined according to the present invention than is the case in conventional methods. In other embodiments the predetermined number may vary in dependence on the identity of the mobile node or on the identity of a class of mobile node.

According to an alternate embodiment, the communications network is capable of handing over a mobile node between access nodes, and the detecting involves monitoring handovers of mobile nodes to access nodes other than the first access node, the handovers including handovers from the first access node to first other access nodes. One advantage of this embodiment is that groups are defined on the basis of historical patterns and thus there is a higher probability that a mobile node will be subsequently accessible at an access node of a group defined according to the present invention than is the case of conventional methods.

In one embodiment the characteristics comprise a probability of a mobile node being involved in a handover between access nodes. Other possibilities include how often a mobile node hands over, how much traffic is carried between ARs (i.e. how much traffic is forwarded between ARs due to a handover), how much traffic is carried on a direct/tunnel link, the type of traffic (quality of service), the class of mobile node and the bandwidth or utilisation of a particular ARs wireless capacity.

According to a second aspect of the present invention there is provided a method of paging for, or broadcasting to, a mobile node of a data network comprising access nodes being linked to other access nodes via data communications links, the method comprising sending a data message to one or more nodes of a group of access nodes defined in accordance with the first aspect of the present invention.

Other aspects of the present invention are set out in the appended claims. There now follows, by way of example only, a detailed description of embodiments of the present invention in which:

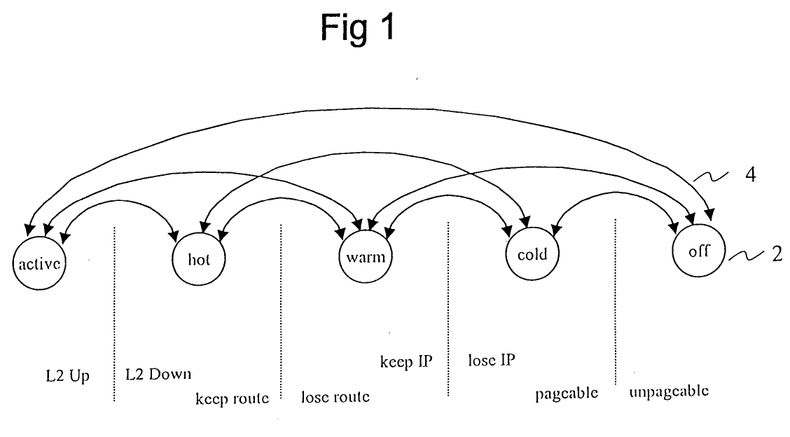

FIG. 1 is a state diagram showing mobile node states and transitions according to the present invention;

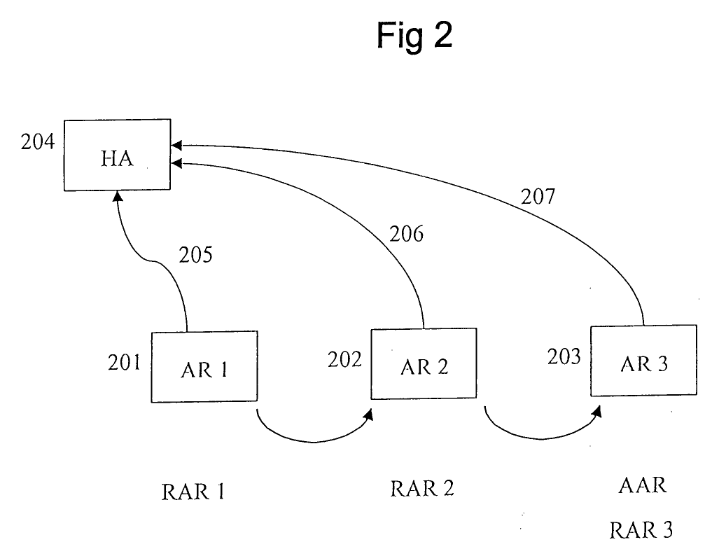

FIG. 2 is a schematic diagram showing a series of access routers of a data network at which a mobile node is successively located and inter-domain location update messages which take place according to the present invention;

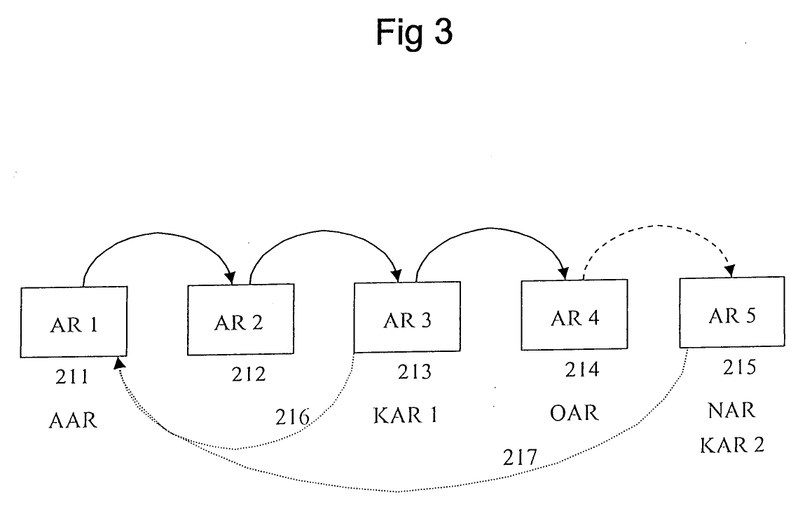

FIG. 3 is a schematic diagram showing a series of access routers of a data network at which a routed mobile node is successively located and intra-domain location update messages which take place according to the present invention;

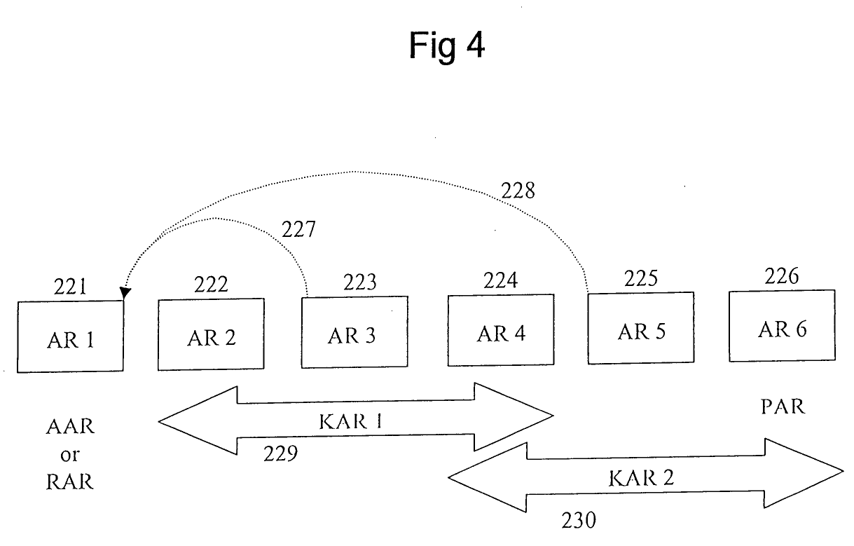

FIG. 4 is a schematic diagram showing a series of access routers of a data network at which an unrouted but pageable mobile node is successively located and intra-domain location update messages which take place according to the present invention;

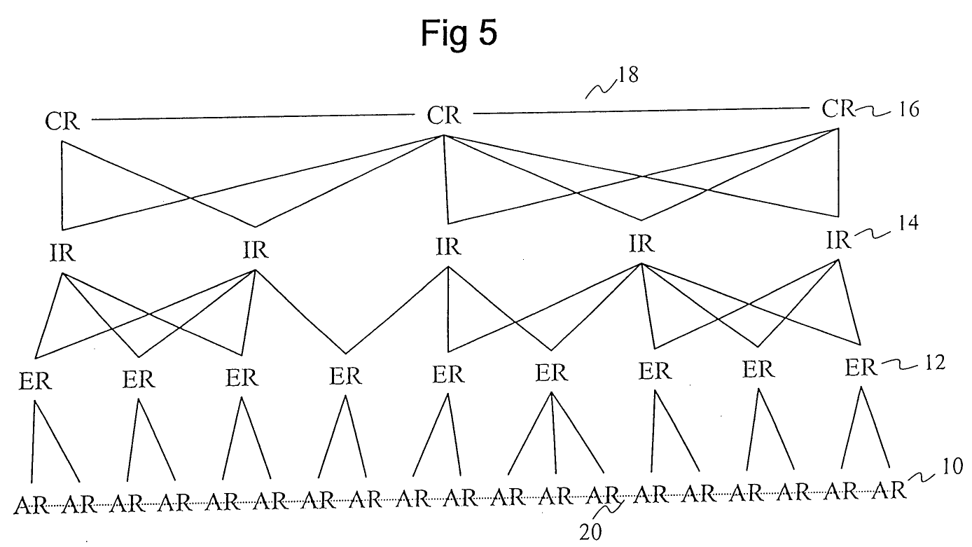

FIG. 5 is a schematic diagram of a typical hierarchical data network suitable for implementing the present invention;

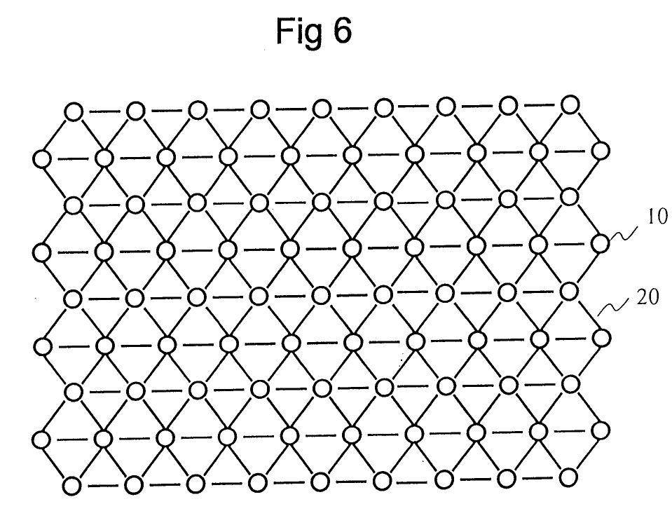

FIG. 6 is a schematic diagram of a set of access nodes interconnected by tunnels suitable for implementing the present invention;

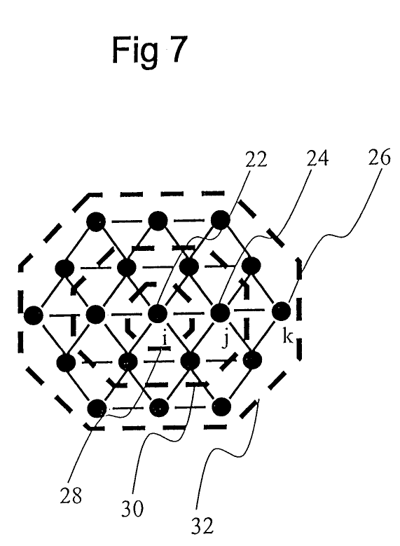

FIG. 7 is a schematic diagram of three low-level location areas centred on an access router and defined according to the present invention;

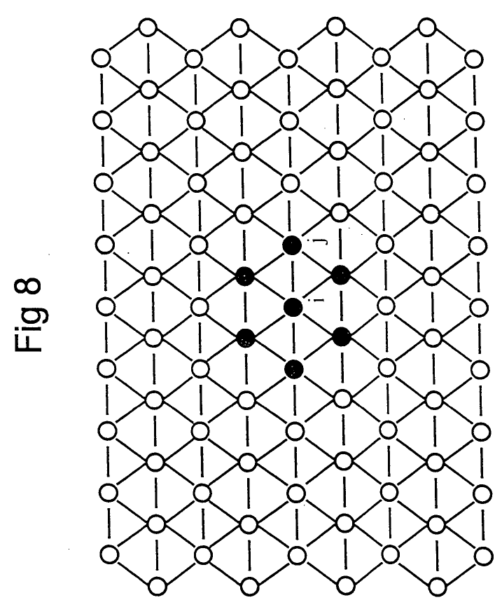

FIG. 8 is a schematic diagram of an access router and its one-hop neighbour set according to the present invention;

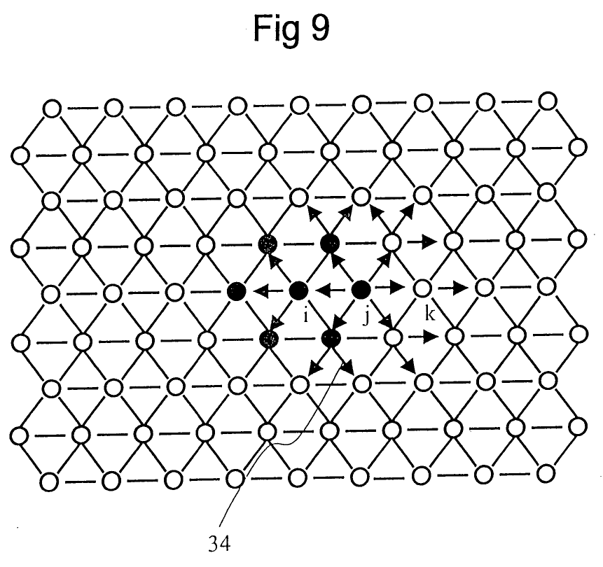

FIG. 9 is a schematic diagram showing transmission of data messages between access routers for forming low-level location areas according to the present invention;

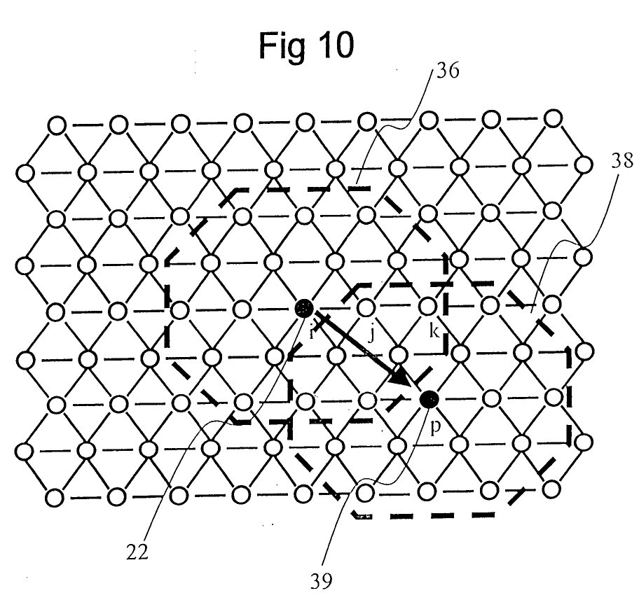

FIG. 10 is a schematic diagram showing two overlapping low-level location areas associated with two access routers with which a mobile node may be associated according to the present invention;

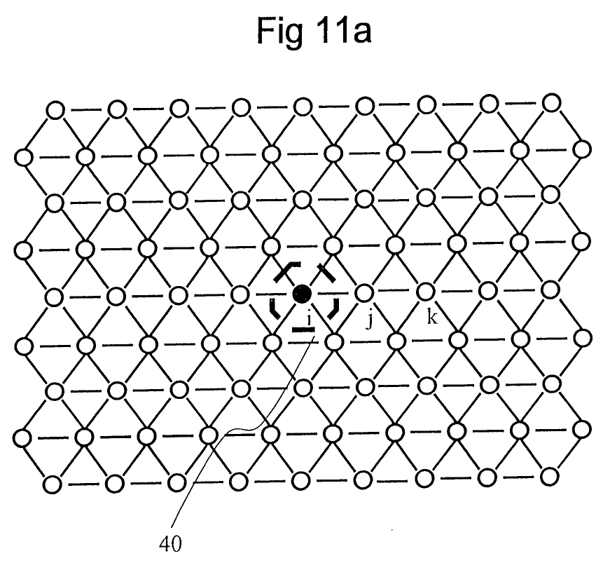

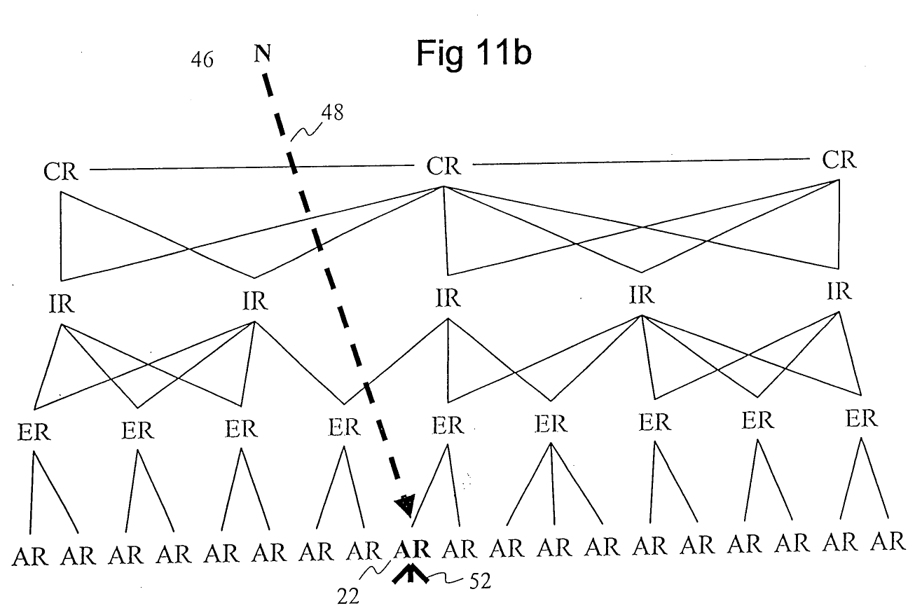

FIG. 11a is a schematic diagram of a low-level location area of radius 1 centred on an access router according to the present invention;

FIG. 11b is a schematic diagram showing an arbitrary node N initiating paging or broadcasting to the low-level location area of FIG. 11 a over the hierarchical data network according to the present invention;

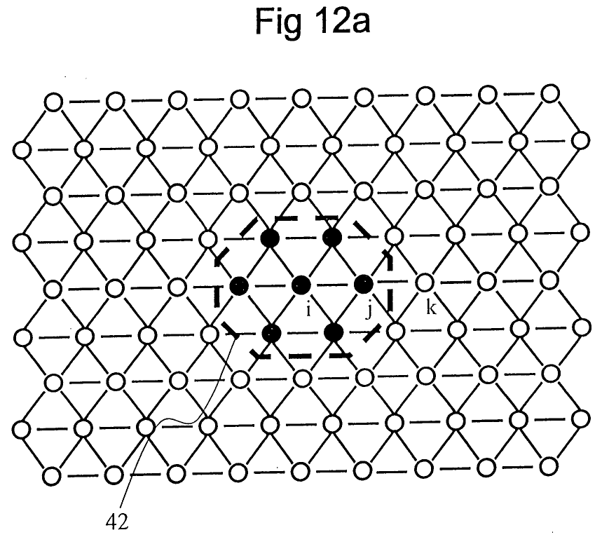

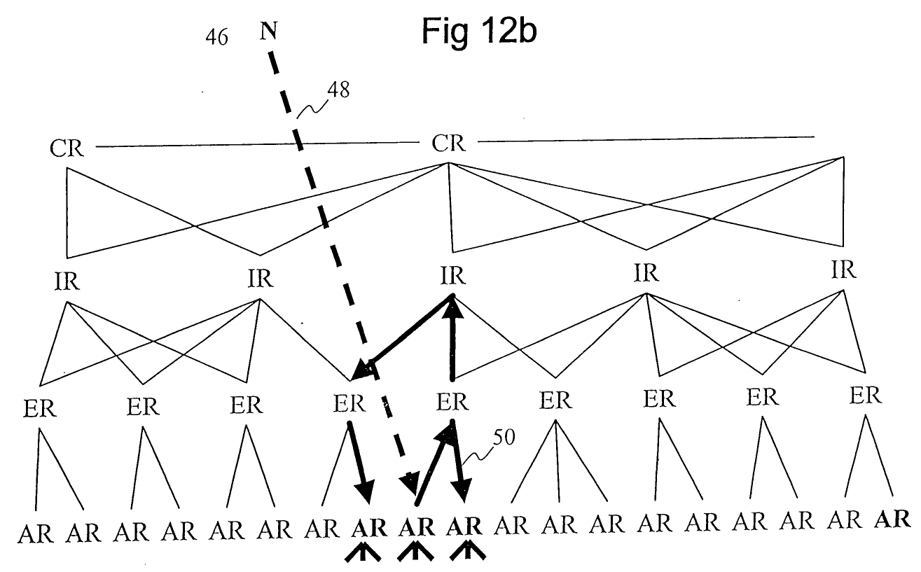

FIG. 12a is a schematic diagram of a low-level location area of radius 2 centred on an access router according to the present invention;

FIG. 12b is a schematic diagram showing an arbitrary node N initiating paging or broadcasting to the low-level location area of FIG. 12a over the hierarchical data network according to the present invention;

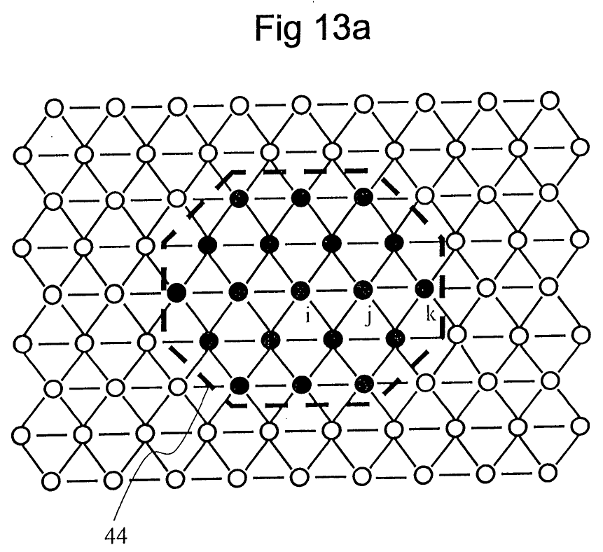

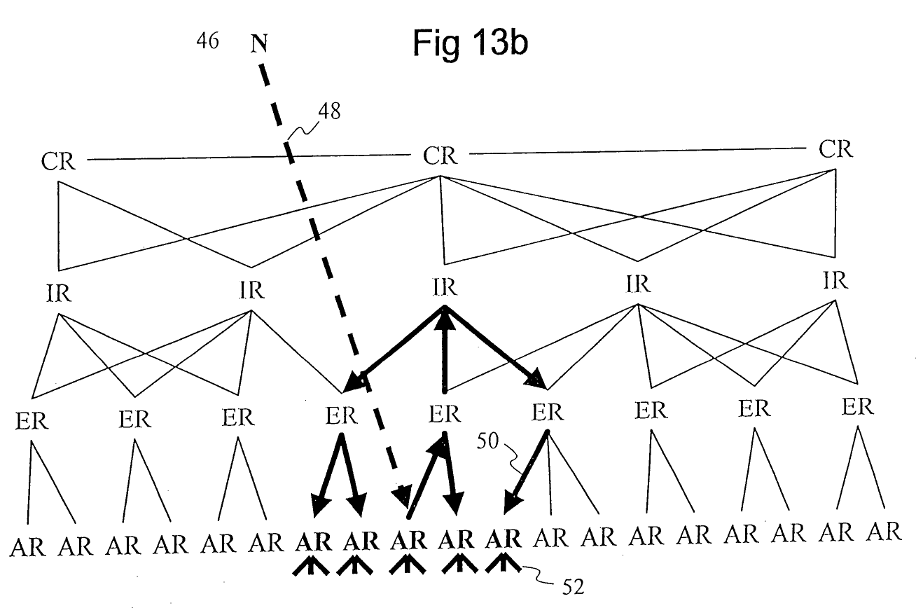

FIG. 13a is a schematic diagram of a low-level location area of radius 3 centred on an access router according to the present invention;

FIG. 13b is a schematic diagram showing an arbitrary node N initiating paging or broadcasting to the low-level location area of FIG. 13a over the hierarchical data network according to the present invention;

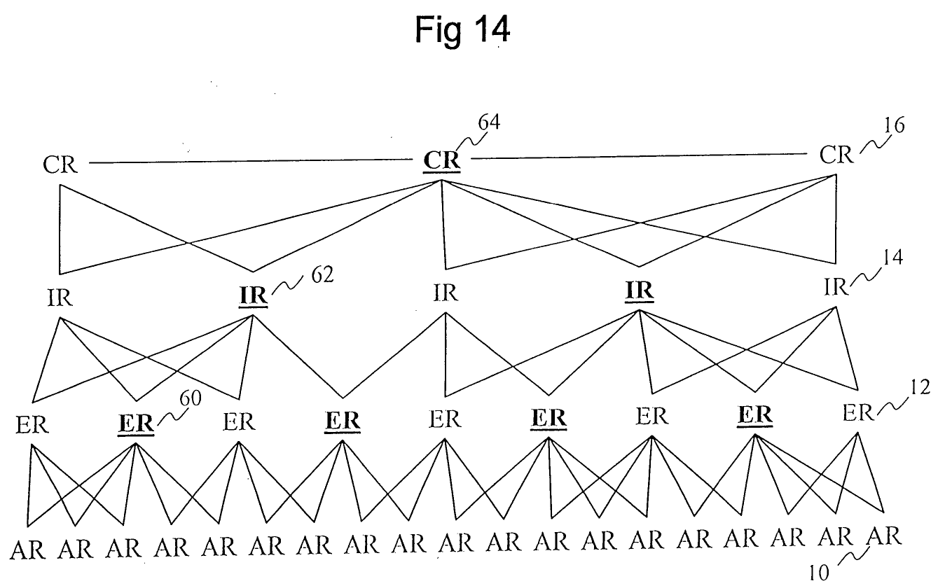

FIG. 14 is a schematic diagram of a typical hierarchical data network comprising a plurality of anycast sinks suitable for implementing embodiments of the present invention;

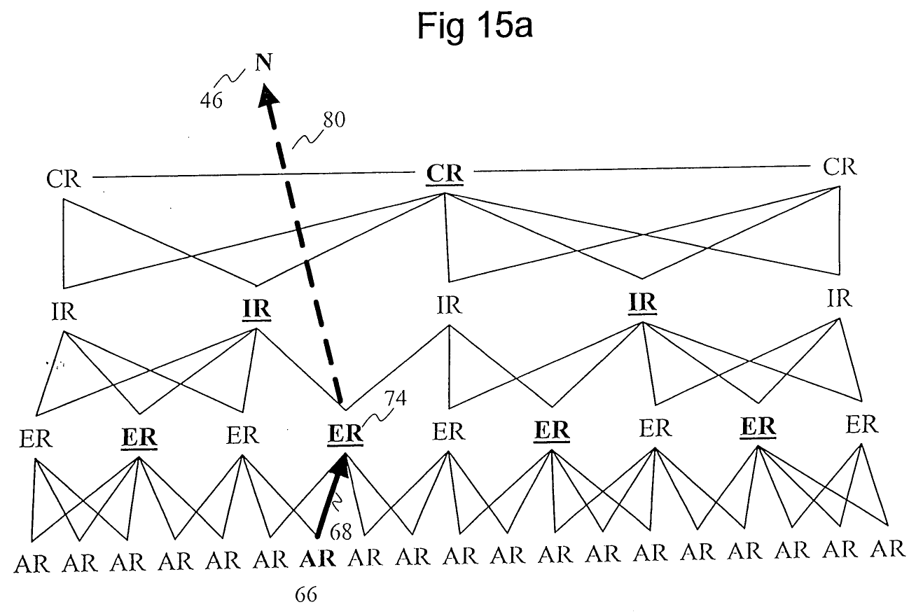

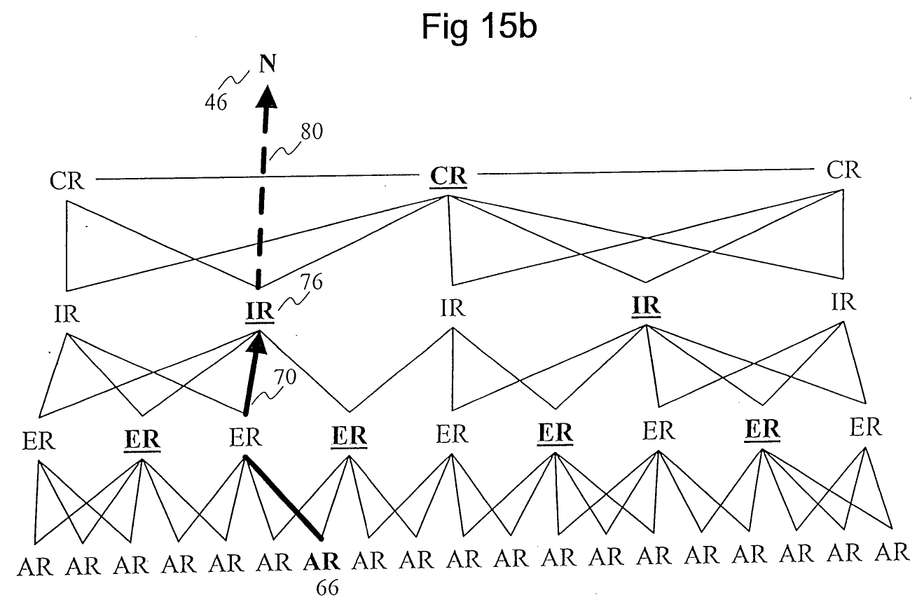

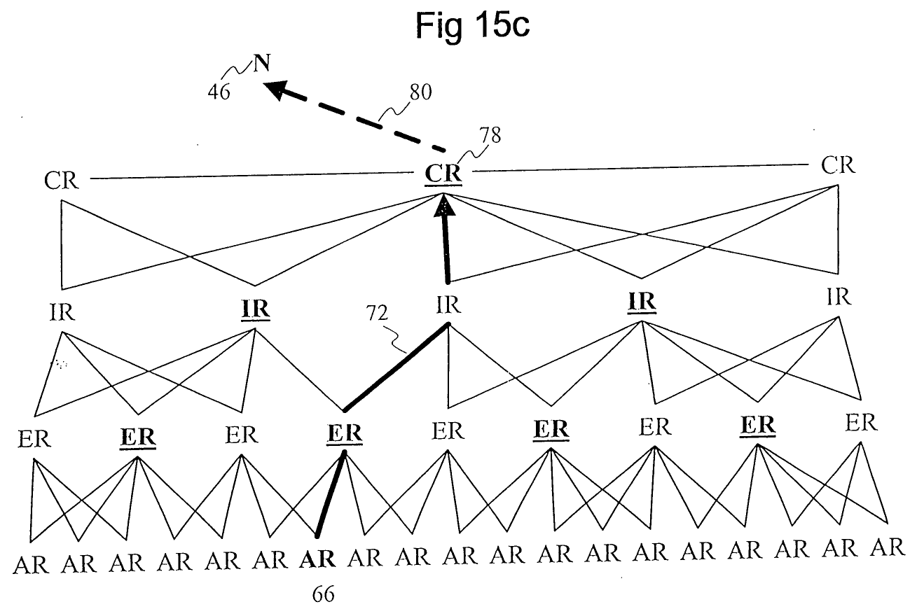

FIGS. 15a to 15c are schematic diagrams showing the transmission of three parallel anycast data messages to anycast sinks at three respective levels of the anycast hierarchy for defining clusters or hierarchical location areas according to the present invention;

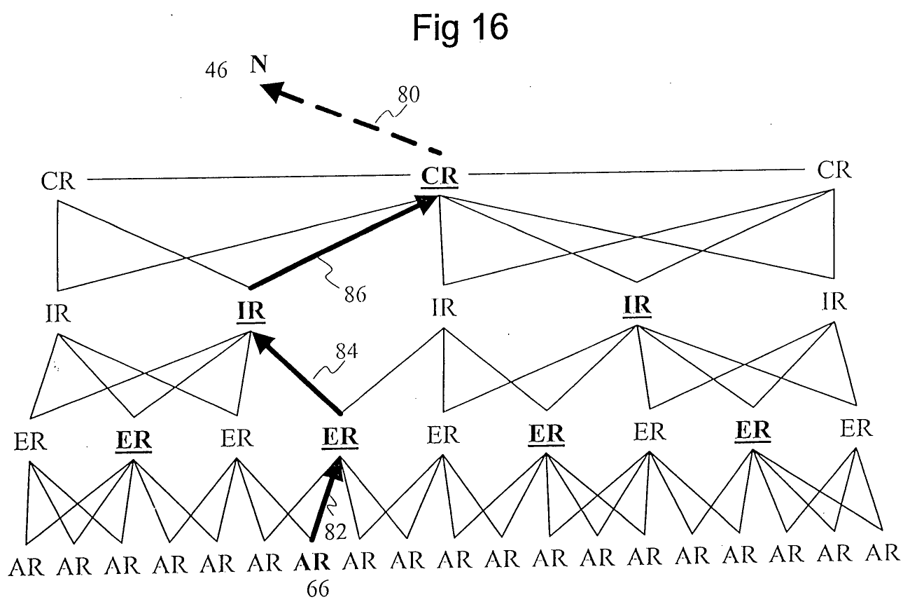

FIG. 16 is a schematic diagram showing the transmission of a sequence of anycast data messages to anycast sinks at three levels of the anycast hierarchy for defining clusters or hierarchical location areas according to the present invention;

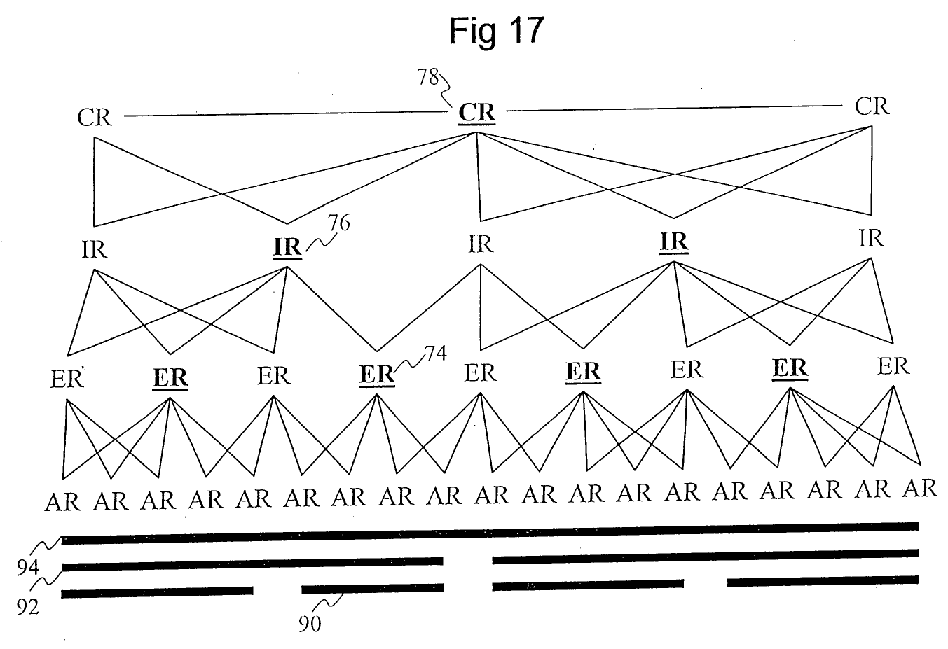

FIG. 17 is a schematic diagram showing clusters or hierarchical location areas at three levels in the anycast hierarchy defined according to the present invention;

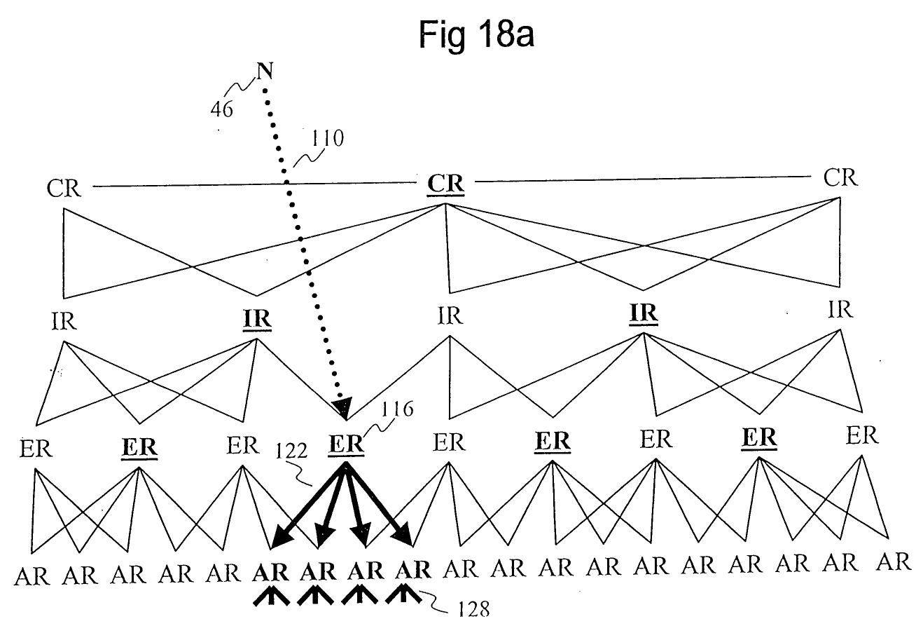

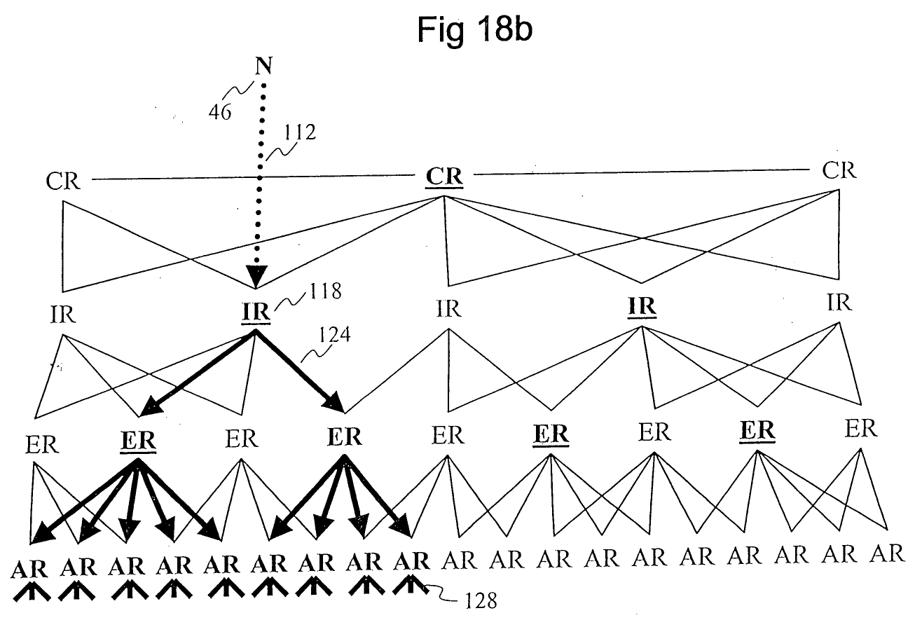

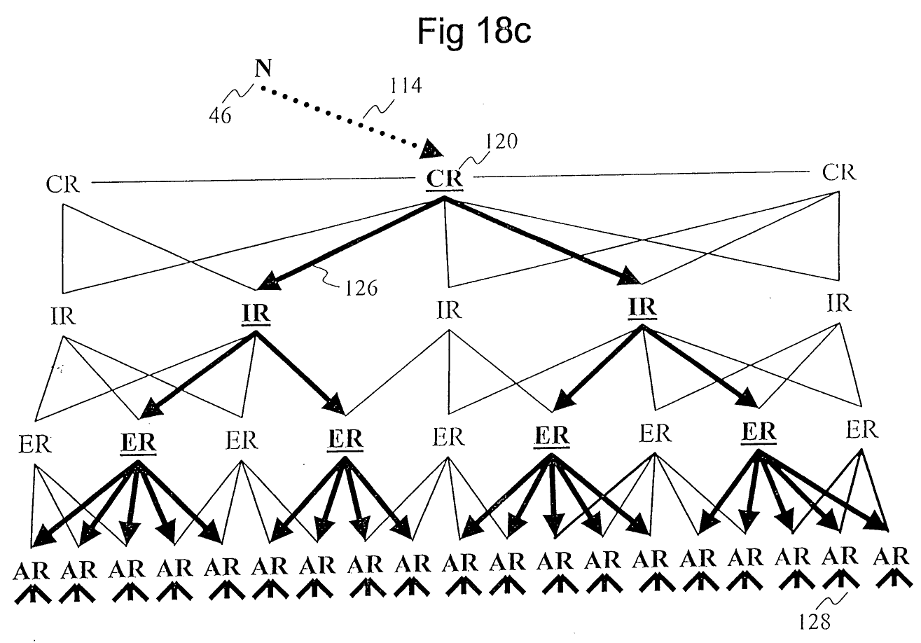

FIGS. 18a to 18c are schematic diagrams showing an arbitrary node N initiating paging or broadcasting to the hierarchical location areas corresponding to three levels of the anycast hierarchy over the hierarchical data network according to the present invention;

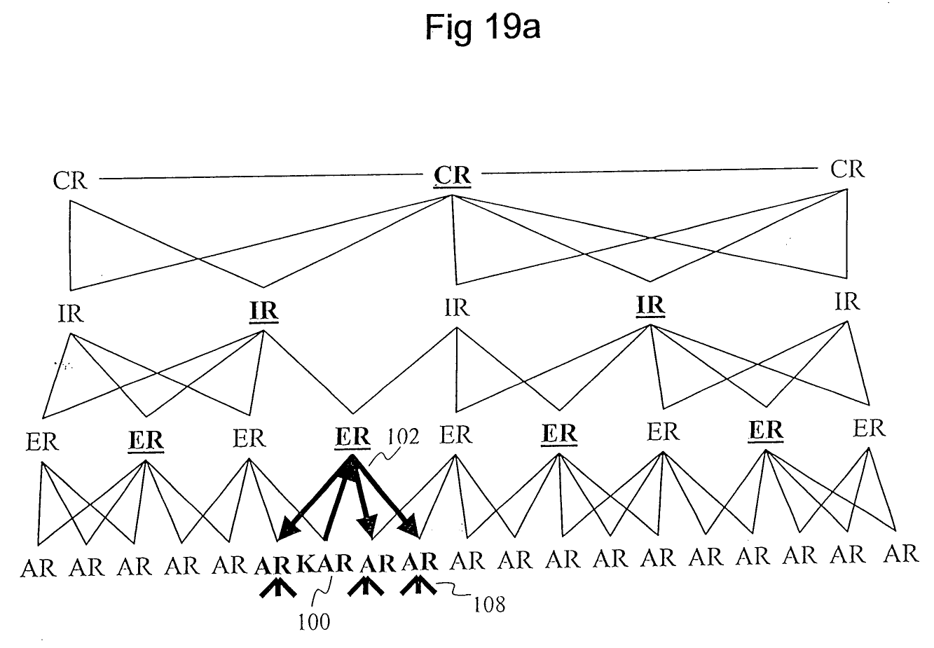

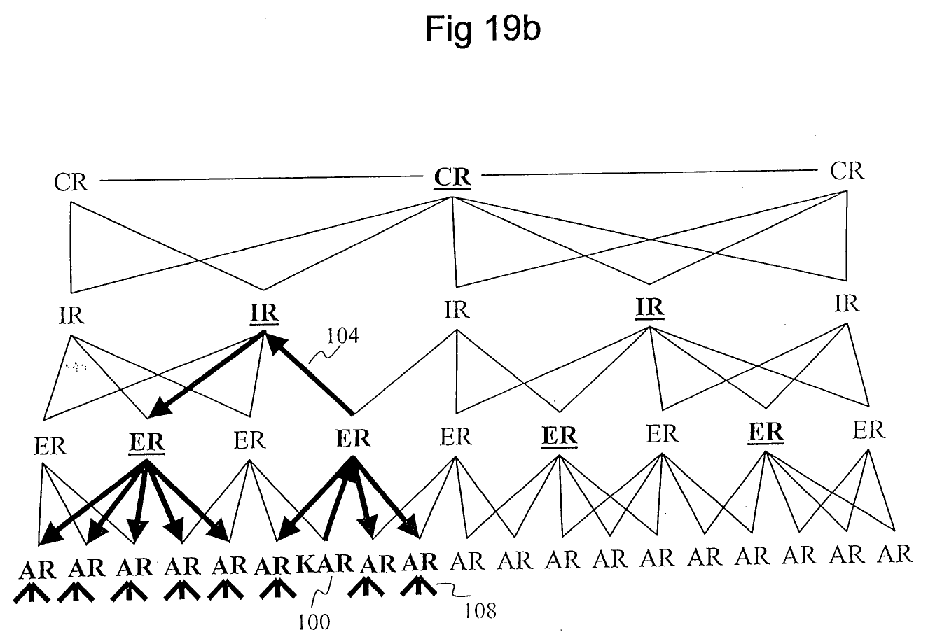

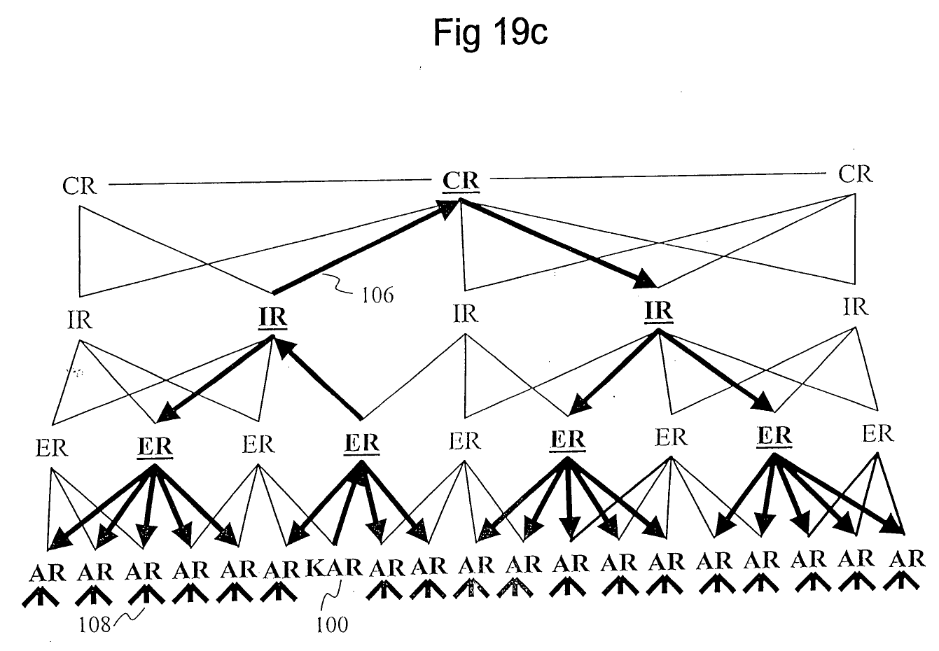

FIGS. 19a to 19c are schematic diagrams showing a known access router initiating paging or broadcasting to the hierarchical location areas corresponding to three levels of the anycast hierarchy over a hierarchical data network according to the present invention;

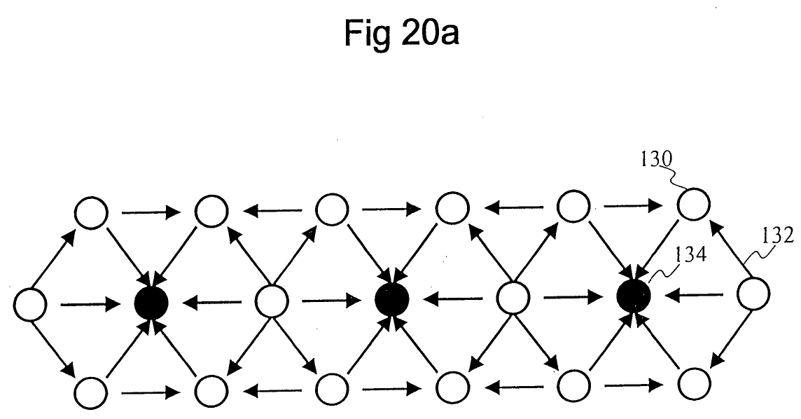

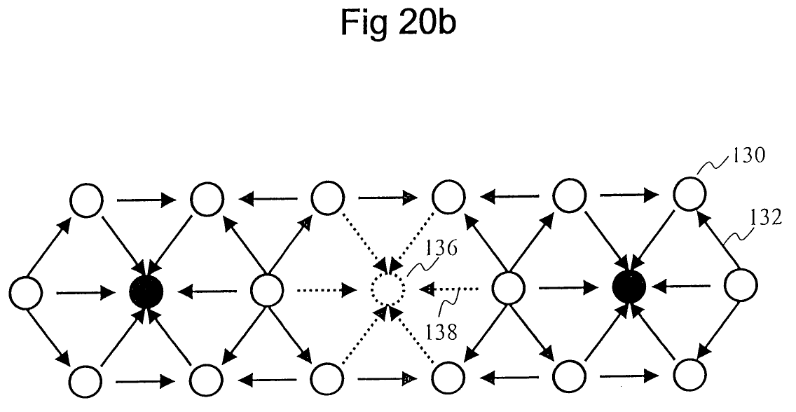

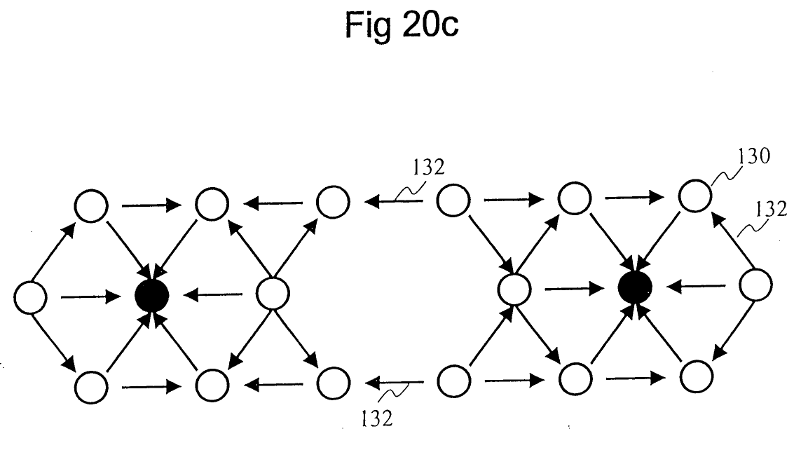

FIGS. 20a to 20c are schematic diagrams showing routing recovery after failure of an anycast sink of the data network.

In EMA, when a MN has data to send or has been paged due to incoming traffic, it connects to the nearest access router (AR)—i.e. a base station—and is brought into the IP routing domain by requesting and being allocated an IP address out of the block of addresses managed by that access router. This AR is known as the allocating AR (AAR). As the MN moves ARs, the allocated IP address moves with it so that higher-layer sessions are unaffected. This is accomplished by modifying the intra-domain routing using host routes to overrule and overwrite the underlying prefix-based (i.e. aggregate) routing to the AAR. Specifically, as the MN moves away from the AAR, a host redirect route is locally injected, during handover between geographically adjacent ARs. This ensures that any traffic on the aggregated AAR route is “peeled-off” and redirected to the new AR. In EMA, routing between ARs and host-specific routing are treated separately. Inter-AR routing is prefix-based, i.e. each AR advertises a prefix address into the domain covering a block of host addresses that it controls. Each host is allocated an interface address covered by the AAR network prefix. While the host is “at home”, packets are routed to the host via this network prefix. Host-specific routing is required only when the MN moves away from its AAR. Host-specific routing state is injected into the network during handover to overrule the MN's “at home” prefix based route, which redirects packets to that MN's current AR location.

Host-specific routing is implemented using a protocol called Mobile Enhanced Routing (MER) which is based on the Temporally-Ordered Routing Algorithm (TORA). TORA uses router IDs to uniquely identify routers separately from their interfaces. In TORA, routers proactively and/or reactively build Directed Acyclic Graphs (DAGs) towards a destination router. Each router is assigned a unique height and no two routers may have the same height. Data flows from routers with higher heights to routers with lower heights over “directed” links. Conceptually, data can be thought of as a fluid that may only flow downhill over downstream links. By maintaining a set of totally-ordered heights at all times, loop-free multipath routing is assured. Data would have to flow uphill to form a loop and this is not permitted. When the destination of a directed link changes, for example when a MN moves to a new cell, the TORA routing may be changed locally by adjusting the heights of various local routers to “inject” a new “downhill” route towards the new destination and to “poison” the old route. EMA proposes four mobile node states—active, hot standby, cold standby and off. An MN is active when it is presently sending and receiving IP data traffic. The MN has a local IP address and has a route pointing to it throughout the EMA domain. The radio layer (L2) and IP layer (L3) are active and movement between ARs generates an IP handover. The MN moves to hot standby when its L2 inactivity timer expires—i.e. it has not been sending or receiving IP data for a specified period. This takes L2 down temporarily whilst L3 is still up which releases radio layer resources for other MNs. The MN therefore maintains the current IP address, has an EMA route for that address in the EMA domain and movement between ARs generates an IP handover. In cold standby, an IP address inactivity timer has expired and the IP address is returned to the AAR and any EMA host routing state is flushed. The MN now only has its ‘identity’ which could be a Network Access Identifier (NAI), an International Mobile Subscriber Identifier (IMSI) or any other unique non-IP MN identifier. The MN may also optionally have a home address from its MIP HA. The L2 is down and movement generates location updates only to the paging system because the MN now has no AAR and no allocated IP address from that AAR. This feature is designed to avoid hoarding of IP addresses when the user is inactive, so that the address can be returned to the AAR for another user. The MN is in off state when it has been switched off and is neither sending location updates nor is pageable.

EMA uses handover messaging to handle routing of data packets towards the MN. A handover can be initiated either by a MN or the network and can be handled at either the old AR (OAR) or the new AR (NAR) corresponding to the old and new base stations between which the MN is being handed over. The OAR is used to coordinate a forward handover when the NAR is known in advance (i.e. planned handover). The NAR is used to coordinate a reverse handover when the NAR is not known in advance (i.e. unplanned handover). Planned handovers may follow a Break-Before-Make (BBM) or a Make-Before-Break (MBB) model according to whether the mobile network can support radio link connections between a single MN and multiple ARs at the same time or not. With BBM, the MN breaks its link to the OAR before making a new link to the NAR. With MBB, the MN may make a new link to the NAR before breaking the old link to the OAR. By definition an unplanned handover must follow the BBM model. In all three cases, a temporary tunnel is optionally created from the OAR to the NAR using the inter-AR routing mechanisms, for forwarding data packets to the MN whilst the host-specific routing is modified to take account of the new location of the MN. For a planned handover, a forward handover message is sent from the OAR to the NAR to establish the temporary tunnel. For an unplanned handover, a reverse handover message is sent from the NAR once the arrival of the MN has been detected, to the OAR to establish the temporary tunnel. After the Make event occurs at the NAR, the NAR and OAR collaborate to “inject” new host-specific routes locally into the EMA domain and to “poison” old host-specific routes so as to avoid looping of data packets whilst the new host-specific routing converges.

Recently, extensions to MIP V4 and MIP V6 have been proposed to enable inter-working between EMA:MER and MIP. These proposals are set out in an Internet draft available at the IETF website identified as draft-oneill-ema-mip-00.txt. For generality, the EMA-MIP proposal does not assume that the home domain of an MN is equipped with a MER protocol nor that all foreign domains visited are equipped with a MER protocol. According to EMA-MIP, a MN has a home address in its home domain allocated as in standard MIP. When roaming in a foreign domain equipped with a MER protocol, the MN also has a CCoA which is equivalent to the EMA address for the MN. The impact of EMA, and the aim of the inter-working architecture, is to enable a whole EMA domain to appear as if it's a single AR for the purposes of MIP tunnelling. In other words, a single CCoA can be used throughout the domain. This is achieved as a result of the ability of the EMA domain to rapidly adjust routing locally to the MN as it moves from cell to cell so that traffic addressed to the CCoA now arrives natively via the new AR rather than by the old AR. This means that the CCoA and all MIP registrations are still valid and hence there is no need to update the forward state in the HA and any correspondent node. The result is faster handover and significant reduction in signalling overheads.

Where the home domain of an MN is itself equipped with a MER protocol, a special case arises. Two approaches may be taken to providing access to and from the MN. In the first model, as soon as the MN moves away from its home link (i.e. the access router that is also its home agent), it must acquire a CCoA which will then remain valid throughout the home domain. If the HA is located at a core network function rather than at an AR, then this approach may be necessary generally. According to the second model, the MN is only assigned a CCoA when it moves out of the home domain. Instead, during the MNs stay in its home domain, the home address, which will be valid throughout the home domain due to host-specific routing, will suffice.

Whether or not the home domain supports a MER protocol, when an MN first moves into an EMA domain, it will behave as if it is booting up in the EMA domain and will be required to undergo authentication. If the MN has immediate data to send or receive, then the MN will be able to get a new CCoA from the AR (becoming the AAR) to which it first attaches to which will then be valid within the domain. If it has no immediate data then the first AR is termed the Registration Access Router (RAR).

The following description of the present invention assumes that a MN is located in an EMA domain as described above, although it will be apparent that the present invention has application to any mobile routing protocol or combination of mobile routing protocols such as MIP v.4 or MIP v.6, Cellular IP, or HAWAII. For generality, the EMA domain is not the MN's home domain, but a foreign domain. Inter-domain mobility management—i.e. between the EMA domain and the home domain—is handled by MIP v.4 or MIP v.6 and the MN has a unique identifier which is its MIP v.4 or MIP v.6 home address. The MN has a HA in its home domain which may or may not be an EMA domain. However, it will be understood that, the present invention is equally applicable where an MN is located in a home EMA domain. It is also applicable to other types of identifiers such as IMSIs or NAIs, and to other types of inter-domain paging using say Authentication, Authorization and Accounting (AAA) protocols or other tunnelling mechanisms such as Layer Two Tunnelling Protocol (L2TP) or IP Security protocols (IPSEC), or signalling protocols such as Session Initiation Protocol (SIP).

According to the present invention, the MN may be in one of five states: active; hot standby; warm standby; cold standby; or off. FIG. 1 shows the five states 2 that an MN may be in with arrows 4 indicating the state transitions an MN may undergo. An MN is active when it is actively sending or receiving data with an AR. Its radio link level interface is active (L2 up); it has an EMA IP address—i.e. a CCoA; and host-specific routing is present in the domain for routing data packets towards the MN. Movement from cell-to-cell generates handover processing in the domain and the injection of new host-specific routing. An MN is in hot standby mode when it is no longer actively receiving or transmitting data traffic with an AR (i.e. when an IP inactivity timer has expired). The MN has an CCoA IP address and host-specific routing within the domain, however, the MN has no radio interface link to the AR. Movement from cell-to-cell generates handover processing and host-specific route injections.

An MN is in warm standby state when the domain no longer maintains host-specific routing for the MN (i.e. when a route holding timer has expired). The MN still has an IP address, but cell-to-cell movement does not generate handover processing. Instead, the MN generates location updates periodically (i.e. on expiry of a location update timer) or on the basis of distance travelled from the cell in which location was last updated. The MN must be paged for when incoming data requires delivery to the MN (e.g. from a CN). An MN is in cold standby when it has no CCoA IP address, either because it has not been assigned one or it has lost a previously assigned address due to inactivity (e.g. a Dynamic Host Control Protocol (DHCP) lease timer has expired). Note that the MN may still have a MIP Home Address (or some other globally contactable identifier) though in cold standby. The MN must be paged for on this identifier when data is incoming. Also, the MN must then register with an AR and be assigned a local IP address (i.e. a CCoA). Finally, an MN is in the off state when it has been powered off. Clearly, the MN is unpageable in this state. The existence of a warm standby state for MNs, and the distinction between warm standby and hot standby, is made possible by the novel distinction between mechanisms for routing and mechanisms for paging in EMA, which mechanisms are truly separate unlike with other intra-domain solutions.

Allowing host-specific routing for MNs to time out in the domain (i.e. when MNs are in warm or cold standby) generates a need for paging mechanisms to locate MNs. Paging mechanisms may be used to bridge the gap between the most forward AR that can be reached through IP routing or forwarding and the actual location of a MN.

When an MN first enters, or is first switched on in, an EMA domain, it registers with an arbitrary AR—the Registering AR (RAR). Authentication Authorisation and Accounting (AAA) is then performed using a proxy AAA server in the EMA domain which proxies back to the AAA server of the MN's home domain. At this stage the MN is in cold standby state and has no local IP address. If AAA is successful, the IP address of the RAR (i.e. a MIP CoA) is reported to the HA using modifications to standard MIP signalling—i.e. an inter-domain location update (LU) is performed. However, the MN may move away from the RAR at which it has registered, and an intra-domain mechanism for tracking and finding it is needed. When in cold standby state, an MN has no local IP address—it has no CCoA. When an MN is about to engage in a data communications session, either originated by the MN or by a CN wishing to communicate with the MN, it is provided with a local IP address in the foreign domain—i.e. a CCoA. The AR at which it is located allocates an IP address from a pool of IP addresses it manages. The IP address of the Allocating AR (AAR) (i.e. a MIP CoA) and the local IP address for the MN (i.e. a MIP CCOA) are reported back to the MN's HA using standard MIP signalling for inter-domain LU. The AAR sets up a radio interface link to the MN which thus changes to active state.

FIG. 2 shows three successive ARs—AR 1 (201), AR 2 (202) and AR 3 (203)—at which a MN (not shown) is located in a foreign domain and the HA (204) of the MN in its home domain to which three successive inter-domain LUs (205, 206 and 207) are made. AR 1 may be the first AR the MN registers to when being switched on or first moving into the domain. The MN is in cold state and AR 1 becomes the first RAR (RAR 1). The identity of RAR 1 is reported back to the MN's HA 204 by inter-domain LU 205 using modifications to standard MIP signalling.

At some time later, the MN has moved to AR 2 without having changed from its cold state (it may or may not have moved via other ARs which are not shown). Generally, it is desirable to periodically update the HA of the MN with new RARs (or AARs) via inter-domain LUs so as to keep any intra-domain LUs localised. These inter-domain LUs may be triggered, for example, by distance-based or hybridised time and distance-based mechanisms such as those of the present invention. If an inter-domain LU occurs while the MN is located at AR 2, AR 2 becomes the second RAR (RAR 2) and the identity of RAR 2 is reported back to the MN's HA 204 by inter-domain LU 206.

At some further time later, the MN has moved to AR 3, again without having changed from its cold state (again it may or may not have moved via other ARs which are not shown), but this time the MN needs to be brought into the IP domain by allocating it with a local IP address. This may be because the MN needs to send IP data or because there is incoming IP data for the MN. AR 3 thus becomes the first AAR (as well as the third RAR (RAR 3)). This triggers inter-domain LU 207 by which the identity of the AAR is reported back to the MN's HA 204.

It should be noted that inter-domain LUs may be made to entities other than the MN's HA, such as a Home Location Register (HLR) or SIP server, or Location Server (LCS), whether for IP or non-IP purposes. It will also be apparent that inter-domain LUs may occur in respect of a MN in any state other than switched off.

It is worthwhile defining the concept of the Forward AR (FAR) at this point. The FAR may be defined as the most forward AR that can be reached through routing towards a MN including both inter-domain and intra-domain routing. In FIG. 2 it will be clear that as the MN successively registers at AR 1, AR 2 and AR 3 whilst in cold (or indeed warm) state, the FAR changes from being AR 1 to AR 2 to AR 3. In general, the FAR will be the current RAR in cold state, the current AAR in warm state and, in hot or active state, it will be the Present AR (PAR)—i.e. the AR at which the MN is actually currently located. While the MN remains located at the RAR or AAR (i.e. the AR which has last been reported through an inter-domain LU), the PAR, FAR and RAR/AAR will all be the same AR. However, when the MN moves away from the RAR/AAR the PAR will clearly be a different AR to the RAR/AAR. In this case, the FAR will either be the same AR as the RAR/AAR (cold or warm state) or the same as the PAR (hot or active state). In hot or active state, routing alone will enable incoming IP data packets to reach the MN, whereas in cold or warm state, an paging mechanism is needed to bridge the gap between the FAR (which can be reached through routing alone) and the PAR (which can't).

While an MN remains located at the RAR/AAR, no additional host-specific routing is required in the domain. Incoming data, from CNs either in the domain or in other domains, will be routed to the RAR/AAR and on to the MN following AAA in the case of a RAR. For example, a CN, knowing the home address of the MN in its home domain, may send a data packet to the HA which will tunnel it towards the RAR/AAR using standard MIP signalling. After an initial data packet has been received by the MN, a binding update may be made between the CN and the MN (i.e. on the basis of the CCOA). However, the MN may move away from the RAR/AAR. If so, and if the MN is in hot or active state, local host-specific routing is generated using the capabilities of the EMA domain. The host-specific routing ensures that data packets will be received by the MN even though it may have moved to another AR in the domain. Thus, in active or hot state, a mechanism for finding the MN is not required as the EMA domain maintains host-specific routing for the MN. However, tracking the MN using optional intra-domain LUs may be useful for other reasons.

FIG. 3 illustrates optional intra-domain location updating when a MN in hot or active state moves away from its current AAR. Intra-domain location updating may be useful because it lets the AAR (and/or any other arbitrary node performing a paging or location-based service such as the HA, a SIP server, a LCS) know of a recent AR at which the MN was located (the Known AR or KAR). However, it is optional because in hot or active state, there is routing all the way to the MN and normally no need for paging mechanisms. FIG. 3 shows five successive ARs—AR 1 (211), AR 2 (212), AR 3 (213), AR 4 (214) and AR 5 (215)—at which the MN (not shown) has been or is located. AR 1 is the current AAR and since registering at AR 1 and being allocated a local IP address, the MN has moved from AR 1 to AR 2, to AR 3 to AR 4 and is now in the process of being handed over from AR 4 the Old AR (OAR) to AR 5 the New AR (NAR). As a result of previous handovers, local host-specific routing has been injected in the EMA domain to create local routes to the MN up as far as AR 4 and as a result of the handover in progress, further local host-specific routing is being injected to reach AR 5 according to the MBB or BBM models described above. AR 3 has been reported back to the AAR as the first KAR (KAR 1) by means of intra-domain LU 216. Now, as the MN is being handed over to AR 5, a new intra-domain LU 217 is triggered to report AR 5 as the second KAR. These inter-domain LUs may be triggered, for example, by distance-based or hybridised time and distance-based mechanisms such as those of the present invention. Note that because local routing is injected at each handover, the FAR moves with the MN as it moves from AR 1 to AR 2 and so on. In general, there will be situations where the current KAR is “behind” the FAR—i.e. is not the same as the PAR.

Once the MN has been inactive for a sufficient period of time—e.g. when an IP inactivity timer has expired—it enters warm standby state and host-specific routing state is cleared from nodes of the network which improves routing scalability among other things. In warm standby state, the MN still has an allocated IP address (i.e. a CCoA) but a mechanism for finding the MN is needed in the event that the MN has moved away from the AAR. Similarly, the MN may change state from warm standby to cold standby—e.g. when a DHCP lease timer has expired—and lose its allocated IP address. In this case the AAR effectively becomes an RAR again. This also covers the initial case when a MN first registers but has no immediate data to send and hence does not acquire a local CCoA IP address. Once again, a mechanism is needed for locating the MN if it has moved away from the RAR/AAR.

FIG. 4 illustrates intra-domain location updating when a MN in warm or cold state moves away from its current AAR or RAR. Intra-domain location updating is needed because it lets the RAR/AAR (and any other arbitrary node performing a paging or location-based service such as the HA, a SIP server, a LCS) know of a recent AR at which the MN was located (a KAR). When IP data traffic to or from the MN needs to be routed, paging may be commenced using the last reported KAR to inform the paging process. FIG. 4 shows six successive ARs—AR 1 (221), AR 2 (222), AR 3 (223), AR 4 (224), AR 5 (225) and AR 6 (226)—at which the MN (not shown) has been or is located. AR 1 is the current AAR or RAR and the MN has moved from AR 1 to AR 2, to AR 3, to AR 4, to AR 5 and finally to AR 6 which is its PAR. There is no local host-specific routing because the MN is in warm or cold state and the routing has been flushed. AR 3 has been reported back to the RAR or AAR as the first KAR (KAR 1) by means of intra-domain LU 227. Similarly, AR 5 has more recently been reported back to the RAR or AAR as the second KAR (KAR 2) by means of intra-domain LU 228. These inter-domain LUs may be triggered, for example, by distance-based or hybridised time and distance-based mechanisms such as those of the present invention. When the MN needs to be located using paging mechanisms, the current KAR, which is the most recent AR known to the RAR/AAR at which the MN has been located, is used.

Two distinct approaches to paging for the MN on the basis of the KAR will be described in detail below. One approach uses Low Level Location Areas (LLLAs) centred on the KAR, such as shown for KAR 1 and KAR 2 at 229 and 230 respectively. The other approach uses Hierarchical Location Areas (HLAs) each comprising the KAR. Note that because local routing has been flushed, the FAR is static at the AAR/RAR. In general, the current KAR is “forward” of the FAR—i.e. it is probably closer to the PAR than the FAR and hence is more useful for paging the MN than the FAR.

In summary, in the inter-domain LU and paging system based on standard MIP, the HA knows either the RAR (cold state), or the AAR and the MN CCoA (warm/hot/active). This enables incoming global IP packets or pages to be forwarded either to the RAR via the RAR CoA (cold), the AAR via the MN CCoA (warm) or the last NAR with a host route for this MN (hot standby) triggering appropriate activity depending on the MN state. The Forward Access Router (FAR) is either the RAR, AAR or the last NAR, and is the most forward AR which can be reached through inter-domain and intra-domain routing. The Present Access Router is that AR at which the MN is currently located and the Known AR (KAR) is the AR from which the MN last reported its Location Area to the FAR. The objective of intra-domain LUs is to inform the FAR (or other entities) of the latest KAR, whilst the objective of intra-domain paging is for the FAR (or other entities) to locate the PAR of the MN on the basis of the KAR.

According to the present invention, two distinct approaches to paging or broadcasting to MNs are provided. These approaches may implemented individually or may be interworked and are suitable for MNs in warm standby or cold standby states as described above. The first approach involves defining low-level location areas (LLLAs) consisting of groups of ARs centred on each AR of a domain. These LLLAs may be used to page or broadcast to a MN which has moved away from its KAR. For instance, when a data packet for a MN in cold or warm state has been routed as far as the FAR, the MN may be paged for in all the ARs of a LLLA centred on the KAR which is known by the FAR. Furthermore, LLLAs are also useful for monitoring the location of MNs in any state other than off. For instance, the MN may listen to broadcasts from its PAR to determine whether it has left the LLLA centred on its KAR and, if so, the MN may initiate an intra-domain LU to update its KAR to become its PAR, thus joining a new LLLA centred around its current location.

The second approach to paging or broadcasting to MNs involves clustering all the ARs of a domain into hierarchically-ordered groups of increasing size and thereby defining hierarchical location areas (HLAs) so that, for example, an MN which has not been located in an LLLA may be paged for or broadcast to in HLAs of increasing size, ultimately over the whole domain if necessary.

Low-Level Location Areas

LLLAs are typically a plurality of ARs which are adjacent or non-partitioned in terms of the topology of the network. There are two network topologies of interest here: the unicast (or physical) topology and the tunnel topology. The former consists of physical wired connections (“links”) between fixed routers. The latter is only logical, and is composed of tunnels (either dynamically created or pre-configured) interconnecting ARs that are “adjacent” in the tunnel topology due to handover-based mobility, i.e. a long term aggregated tunnel “link” is established between two ARs if a sufficient amount of mobile handover occurs between these two ARs, over that aggregated tunnel. For example, in EMA domains, pre-configured aggregated or dynamic tunnel links are created as a result of mobile handover as has been described above. Under normal operation both topologies are non-partitioned. The unicast topology consists of a hierarchical mesh whereas the tunnel topology is a flat mesh (i.e. non-hierarchical or one-level). The number of physical routers between adjacent ARs in the tunnel topology may vary widely.

FIG. 5 shows a typical hierarchical mobile data network consisting of access routers 10, edge routers 12, intermediate routers 14, and core routers 16. The various routers are multi-homed (they have two or more network addresses) and have multiple physical data links (shown as solid lines such as physical data link 18) to neighbouring routers. Also shown in FIG. 5 are tunnel data links (shown as dotted lines such as tunnel data link 20) between neighbouring ARs which may be pre-configured in the network or dynamically determined as a result of mobile handover induced tunnel creation such as occurs in EMA domains.

FIG. 6 shows a “top-view” of the tunnel topology showing a plurality of ARs (represented by circles such as AR 10) and tunnel links between ARs (represented by solid lines such as tunnel link 20). Of course, physical and tunnel links may exist between any two ARs of a network and FIGS. 5 and 6 are merely illustrative of a hierarchical network with a set of physical and tunnel links between ARs. Mechanisms for defining and maintaining LLLAs in the tunnel topology will now be described, but it will be understood that the present invention applies equally to defining or maintaining LLLAs in the unicast or physical topology.

According to the present embodiment, low-level location areas (LLLAs) may be defined and maintained in the domain using a source-specific multicast (SSM) routing protocol. SSM is a type of multicast protocol and has been defined by the IETF in an Internet draft draft-holbrook-ssm-00.txt available at the IETF's website http://www.ietf.org. The standard multicast service model is defined in Request For Comment (RFC) 1112. Multicast provides a messaging service in which one-to-many and many-to-many group communication is possible. A message may be sent to an address G specifying a host group of multiple entities. SSM, however, provides a service in which a message with a specified destination address G is delivered only to each entity that has specifically requested the reception of messages sent to address G by source S. Thus, SSM messages are specific not only to destination address G but also specifically from source address S. The network service identified by (S,G), for an SSM address G and a source host address S, is referred to as a channel. The key point is that a channel is identified by a combination of a unicast source address S and a multicast destination address G. SSM messages sent from an entity with source address S to host group G will only be delivered to those entities that have subscribed to the channel (S, G).

For each AR, a set of LLLAs may be defined which are centred on that AR (the central AR of a LLLA will be the KAR of a particular MN when it comes to paging for than MN) and consist of all adjacent ARs within a given number of tunnel hops as follows. Each AR in the domain has associated with it a set of SSM channels. The source address S of each of the SSM channels is the unicast address of the AR. The destination address G is annotated by an integer, from 0 to n, corresponding to a number of tunnel hops radius around the AR. Thus, each AR has (n+1) SSM channels associated with it. Each SSM channel for each AR has a corresponding LLLA. Thus, each AR has (n+1) LLLAs centred on it consisting of all adjacent ARs within 0 to n tunnel hops respectively. The composition of the (n+1) LLLAs for a given AR is defined as the set of ARs which have subscribed to the corresponding (n+1) SSM channels centred on the AR. How neighbouring ARs subscribe to a given SSM channel will shortly be described below. FIG. 7 shows the tunnel topology of FIG. 6. Three ARs 22, 24, and 26, denoted i, j, and k are also shown. AR i is one tunnel hop away from AR j, AR j is one tunnel hop away from AR k, and AR i is two tunnel hops away from AR k. Centred on AR i are three LLLAs 28, 30, and 32. Let us denote the SSM channels which define the three LLLAs as (i,0), (i,1) and (i,2) respectively where LLLA (i,0) only includes AR i itself and is used to address only its directly connected MNs.

The process of subscription to the SSM channels which define LLLAs takes place dynamically and may vary as the tunnel topology varies as a result of mobile handover-induced tunnel creation such as occurs in EMA domains. Initially, the only neighbouring ARs a given AR knows of are its immediate 1-hop tunnel neighbours—i.e. the neighbouring ARs with which it has tunnel links. These 1-hop tunnel neighbours are added to a soft-state tunnel link state data-base maintained by each AR. The tunnel link state database records the identity of the tunnel neighbour by its unicast IP address or Router ID and records the number of tunnel hops away each tunnel neighbour is. How an AR discovers neighbours two or more tunnel hops away to add to its tunnel link state database is as follows. Initially, each AR, knowing its 1-hop tunnel neighbours, subscribes to all the SSM channels centred on its 1-hop tunnel neighbours. FIG. 8 shows a AR i with tunnel links to six 1-hop tunnel neighbour ARs. AR j is one such tunnel neighbour. As AR i discovers tunnel neighbour AR j, it subscribes to the SSM channels (j,1), . . . (j,n) centred on AR j.

Periodically, each AR advertises the composition of its 1-hop tunnel neighbour set from its tunnel link state database by multicasting their unicast IP addresses over its SSM channels. For example, AR j advertises the composition of its 1-hop tunnel neighbour set over its SSM channels (j,1), . . . (j,n). Any AR listening to one of these channels—i.e. any AR that has subscribed to one of (j,1), . . . (j,n)—adds this tunnel “link state” information to its own tunnel link state database. For example, in FIG. 9, AR k is one tunnel hop away from AR j and is thus one of AR j's 1-hop tunnel neighbours. AR j advertises its 1-hop tunnel neighbour set over its SSM channels, as shown in FIG. 9 by arrows 34. Consequently, by having subscribed to (j,1), AR i learns the identity of AR k. Knowing that AR k is 1 hop from AR j and that it heard of AR k over (j,1), AR i knows that AR k is two hops from itself. Provided AR k is within n hops of AR i, i.e. provided n>=2, AR i adds AR k to its tunnel link state database and subscribes to the SSM channels (k,2), . . . (k,n). It then begins hearing link state advertisements from AR k and learns of 3-hop neighbours and so on. Eventually, each AR in the domain learns of all the ARs within n tunnel hops of itself and adds them to its tunnel link state database.

Where an AR hears the identity of another AR over more than one channel, it is able to ascertain the distance in tunnel hops to the other AR because it will always be 1+ the distance of the nearest AR on whose channel the identity was broadcast, unless the AR is a 1-hop tunnel neighbour itself. In general, if an AR q is m hops away from an AR p, where m<=n, then, upon learning of AR p, AR q adds AR p to its tunnel link state database and subscribes to AR p's SSM channels (p,m), (p,m+1), . . . , (p,n). Thus SSM is used to disseminate tunnel “link state” information to all ARs within n tunnel hops hence maintaining a localized link state database on the tunnel topology to guide subscription to SSM groups. This process is fully distributed (in the sense that the global process is not carried out by central nodes, but is distributed across the network), localized (in the sense that signalling is kept at the edges of the network and close to the physical or topological areas concerned in the process) and robust (in the sense that it is not dependant on any one node or small group of nodes which would be points of potential global failure).

When a MN powers on, it registers to its PAR, and this PAR becomes its RAR, its FAR and also its KAR, which is clearly at the centre of the MN's LLLA (defined by its central AR the KAR of that MN). The MN also records the identity of this KAR. Each AR periodically multicasts the set of LLLAs (each identified by its central AR) in which that AR resides over a paging or broadcast channel (this it knows from the tunnel link state database). The MN listens to these transmissions. When it receives a transmission that does not contain the identity of the KAR to which it last registered (i.e. when it has left the region covered by the LLLA centred on the KAR), it sends a micro intra-domain LU to the FAR (which in this case is also the RAR) informing it of its PAR which becomes the new KAR for the MN stored at the FAR. This basically means that when the MN has moved n tunnel hops (where n is the LLLA radius in the tunnel topology) away from the original AR where it first registered, it sends a location update to change its LLLA which is once again centred atop the MN on its PAR. Note that this LU could be propagated by the RAR into the inter-domain paging system based on distance, time, policy etc, causing the KAR to periodically become the new RAR to help localise intra-domain LU traffic. When a FAR needs to contact a MN it tells the KAR to page in its LLLAs. So the KAR, AR i, first pages the mobile in its cell. If not present, it may simply multicast either serially or concurrently the page to its SSM channel (i,n) (or perhaps first a smaller set such as (i,m), 1<m<n) and all ARs receiving this then page for the MN in their cells.

FIG. 10 shows two overlapping LLLAs (36 and 38) of radius 2 tunnel hops (i.e. n=2), centred on AR i (22) and AR p (39) respectively. A MN initially located at AR i (the KAR) will remain within the LLLA centred on AR i provided it is registered with an AR within two tunnel hops of AR i. According to the present embodiment, when the MN moves outside this LLLA, say to AR p, it hears that is no longer within its original LLLA because it is listening to the paging or broadcasting channels on which each AR multicasts the set of LLLAs in which it resides and does not hear the identity of AR p. The MN thus knows it must update its location area identified by its KAR and stored in the FAR by sending a LU to the FAR reporting AR p (its new PAR). The MN is then associated with a new LLLA centred on AR p. This will always be possible because each AR of the domain has a LLLA associated with it. Thus, wherever the MN has moved immediately after it leaves its original LLLA, it will be associated with a new LLLA which is optimally centred on its PAR. This system of fully overlapping LLLAs, combined with the various options for re-centring described above, solves the unbalanced “knife edge” problem of a fixed LA approach where MNs are frequently found at the edges of non-overlapping location areas. Although the problem is less acute with partially overlapping location areas, the present embodiment provides a more optimal solution than any known non-overlapping or partially overlapping system because MNs will normally find themselves optimally centred within a LLLA whenever they change LLLA.

The mechanism may optionally be hybridised with time-based mechanisms to periodically refresh location when necessary due to insufficient movement. It may also optionally be hybridised with direction-based tracking to cause the MN to join the outskirts of a LLLA centred in its direction of travel which would further reduce LU signalling as the LLLA would be valid for a longer distance (and time). The numeral n, which represents the radius of an LLLA, may of course vary. Furthermore, it may vary from AR to AR and be auto-configured and optimised through learning, as a result of historical paging success and LU traffic. Reporting the PAR via the KAR following a page enables the KAR to maintain statistics of MN movement and hence optimise tunnels and LLLA (including the value assigned to n and searching order through smaller LLLAs of radius m<n). Thus, the area of coverage of an LLLA may be tuned to the requirements of the geographical area it serves or the requirements of the expected population of MNs it serves. For example, in areas of fast moving MNs, such as motorways, the radius of LLLAs may be larger.

The approach is near optimal. As a node moves and then updates, by changing (and re-centring) its LLLA it effectively moves its LLLA. The approach permits topological distance-based paging (where the topology is logical and reflects node handover) which is efficiently mapped to the unicast topology via multicast. It consists of efficient multicast-based based dissemination of n-hop tunnel link state topology information to build tunnel link state databases. The SSM trees are built on the unicast topology, but are based on multicast group subscription and formation reflecting the tunnel topology (which reflects movement and geography) that are learned from the link state databases. Thus the SSM trees account for and repair any mismatch between the tunnel topology and the unicast topology.

The approach also has a low signalling cost. Each AR must periodically broadcast a packet containing the set of LLLAs to which it belongs (essentially a list of AR identifiers) over its air interface for the MN to track. It must also periodically multicast its set of one-hop tunnel neighbours over its SSM channels. The MN location updates are sent to the FAR near optimally (as FAR can be periodically localised), based either on its movement or the required refresh time as necessary. Since a mobile's LLLA effectively moves with it and re-centers with each location update, the probability of a MN not being in its most recent LLLA when paged is significantly lower than all prior schemes, thus lowering the paging overhead relative to prior approaches. This permits more focused, localized paging that more efficiently utilizes system resources.

The SSM channels associated with a given AR form a set of LLLAs in which MN may be broadcast to or paged for—for example, when it has strayed away from the KAR to the PAR. FIGS. 11a, 12a and 13a show LLLAs 40, 42, and 44 centred on AR i in the tunnel topology and of radius 0, 1 and 2 tunnel hops respectively corresponding to the SSM channels (i, 0), (i, 1) and (i, 2). FIGS. 11b, 12b and 13b respectively show the corresponding unicast topology in which paging or broadcasting is initiated by an arbitrary node N 46 (which may be, for example, the AAR, RAR, or any reachable FAR such as the last AR with a host route the HA of the MN or any arbitrary node which may perform a paging or locating service such as a SIP server, LCS etc.) sending a broadcast message or paging message to the three LLLAs by first unicasting (shown by dashed arrow 48) the request message to the KAR which is the central AR i 22 and then, in the case of LLLAs of radius 1 and 2 tunnel hops (i.e. FIGS. 12a, 12b, 13a and 13b) AR i multicasting the message over the corresponding SSM channels (i,1) and (i,2). The multicast messages (shown by solid arrows 50) are efficiently sent over the unicast topology. ARs hearing the message then instruct their associated base stations to page or broadcast to MNs in their cell over the radio interface (shown by solid lines 52). The MN or PAR responds by replying to the paging request to the FAR either directly or via the KAR as described above.

If a page in a given LLLA fails to find a MN, the paging node N, for example the FAR, may initiate pages in LLLAs of greater area. For instance, the paging node may first request a page in the LLLA of radius 1 tunnel hop centred on the KAR. If this fails because the MN has moved from the KAR, then the paging node may request a page in the LLLA of radius 2 tunnel hop centred on the KAR, and then the LLLA of radius 3 tunnel hop centred on the KAR, and so on up to LLLAs of radius n, the maximum tunnel radius in the LLLA paging approach. Preferably, a mechanism is employed to ensure that the same ARs are not searched twice so that the series of pages forms an expanding ring search. This may be achieved by the paging node including in each second and subsequent paging request the addresses of the SSM groups which have previously been used to page for the MN. The KAR may then determine which ARs in the current LLLA of interest have already been used to page and unicast messages to the remaining ARs to instruct them to page for the MN over the air. Alternatively a modified multicast routing protocol may be used to send messages only to those members of the current LLLA of interest not also being members of the previously paged LLLAs. Alternatively, each AR maintains a soft state database listing recent paging requests for MNs so that multicast messages to page over the air for a MN which has recently been paged for already are ignored.

Hierarchical Location Areas

The second approach to paging or broadcasting to MNs involves clustering the ARs of the network into hierarchically-ordered groups of increasing size and thereby defining Hierarchical Location Areas (HLAs). The ARs of the domain may be clustered and HLAs thereby defined using an anycast routing protocol. The standard anycast service is defined in the IETF's RFC 1546. An anycast address is typically associated with two or more hosts which serve that address. However, the anycast service is not like the multicast service because an anycast datagram from any source will be sent to only one of the hosts serving the anycast address. The point is that any one of the serving hosts will do. Anycast routing ensures that a packet sent to an anycast address will be received by the “nearest”—in terms of a node to node “distance” measurement or metric anycast host of all the anycast hosts serving the anycast address.

ARs of a domain may be clustered into hierarchically-ordered groups as follows. Firstly, a subset SO of all the ARs of the domain, containing less members than all the nodes of the domain, are selected and designated as level 0 (L0) anycast hosts (or sinks) serving a single anycast address—i.e. a L0 anycast address. Now, a further subset S1 containing less members than S0—i.e. a subset of all the nodes of the domain smaller in number than S0 but not necessarily itself a subset of S0—are selected and designated as L1 anycast sinks serving a single L1 anycast address. A further subset S2 containing less members than S1 are selected and designated as L2 anycast sinks serving a single L2 anycast address, and so on until a desired number of levels is reached. Preferably, the sinks of all levels are selectively placed within the network so as to maximize the inter-sink distance in terms of the anycast metric, or some other network metric. However, any number and placement of anycast sinks may be used provided the above conditions are satisfied. Also preferably, if the domain is hierarchical, the sinks of S0, S1 , S2 . . . are selected to be nodes of increasing levels in the hierarchy of the network—such as edge routers, intermediate routers and core routers respectively. However, the network's topology may have any composition and need not be hierarchical. FIG. 14 shows the hierarchical domain of FIG. 5 with ARs 10, ERs 12, IRs 14 and CRs 16. Three levels of anycast sinks are shown consisting of 4 ERs at L0 (such as ER 60), 2 IRs at L1 (such as ER 62), and 1 CR at L2 (ER 64). These sinks form the subsets S0, S1 and S2 respectively.

According to one embodiment of the present invention, each AR of the domain sends anycast datagrams in parallel to each of the anycast addresses at the various levels in the hierarchy. For example, if three levels have been provided, then three anycast datagrams are sent in parallel from each AR, one to the L0 anycast address, one to the L1 anycast address and one to the L2 anycast address. The anycast routing protocol automatically sends the datagrams to the “nearest” anycast sink at the appropriate level. FIGS. 15a, 15b and 15c respectively show the 3 parallel anycast datagrams being sent from an AR 66 to each of the three anycast addresses corresponding to the three levels of the domain of FIG. 11. The path followed by the anycast datagrams is shown by solid arrows 68, 70 and 72 respectively in FIGS. 15a, 15b and 15c, although a datagram may follow a different paths in reaching the same receiving anycast sinks on different occasions. The identities (e.g. IP addresses or Router IDs) of AR 66 and the receiving anycast sinks 74, 76 and 78 are sent to an arbitrary node N, which for example could be the FAR or the originating AR, by means of 3 unicast messages shown as dashed arrows 80 in FIGS. 15a, 15b and 15c. Node N therefore obtains domain wide information of the mapping between ARs and their sink at each level of the hierarchy. Alternatively, node N for each AR can be different producing a more distributed mapping resource.

According to an alternate embodiment of the present invention, rather than send parallel anycast datagrams, each AR of the network sends only one anycast datagram to the lowest level anycast address—i.e. the L0 anycast address. The anycast routing protocol automatically sends the datagrams to the “nearest” anycast sink in L0. On receiving a datagram from an AR, each L0 sink in turn sends a further anycast datagram to the L1 anycast address. Again the anycast routing protocol automatically sends the datagrams to the “nearest” anycast sink at L1. The receiving sinks of L1 in turn send an anycast datagram to the L2 anycast address, and so on up the hierarchy until the top level is reached. The identities of the sequence of anycast sinks through which datagrams originating from an AR pass is recorded in each successive datagram along with the identity of the originating AR to form an “anycast vector” (AV) which is a macro intra-domain LU. Thus, the anycast datagram reaching a sink at the highest level in the anycast hierarchy contains information identifying the originating AR and each of the lower level sinks through which an anycast datagram was received and sent on behalf of that AR. Typically, the identifying information will be the unicast IP address of the AR or sink. FIG. 16 shows the sequence of 3 anycast datagrams being sent from an AR 66 up the anycast hierarchy (which in this illustration coincides with the hierarchy of the domain) to a top-level anycast sink at L2. The three anycast datagrams are shown by solid arrows 82, 84 and 86. The AV LU is sent to an arbitrary node N, which for example may be the FAR previously discussed or the originating AR, by means of a unicast message shown as a dashed arrow 80.

The parallel and sequential embodiments of the present invention described above enable ARs of a domain to be clustered into hierarchically-ordered groups. In both the embodiments, the ARs which sent the anycast datagrams may be clustered together according to which sink in each level receives anycast datagrams directly or indirectly originating from each AR. This may be performed by the node (or nodes) N on the basis of the information sent to it from all the sinks in respect of all the ARs. At each level of the hierarchy, a set of non-overlapping clusters of ARs is defined, one cluster for each sink. FIG. 17 shows the domain of FIG. 14 with three clusters of ARs 90, 92 and 94 (shown by solid lines spanning a number of ARs), each cluster corresponding to one of the anycast sinks 74, 76 and 78 of the domain. Since there are less sinks at higher levels, the clusters of ARs are generally of increasing size. Each AR is a member of a cluster at each level and the set of all clusters at each level spans all the ARs of the domain. In effect, the anycast routing protocol has been used to partition the ARs of the network into non-overlapping clusters at each level of the hierarchy.

The clusters of ARs at the various levels of the hierarchy may be used to define HLAs for paging and broadcasting to MNs, for example where MNs have strayed significantly from their KAR. Various mechanisms for paging or broadcasting to an MN over HLAs may be employed as follows. According to one method for paging or broadcasting to an MN over HLAs, ARs of the domain periodically send anycast datagrams according to the sequential model described above. This periodically refreshes the composition of the HLAs in the event of any changes in the topology of the domain (for instance, as a result of router failure). As each anycast datagram is received by a sink at each level of the hierarchy, soft reverse-path forwarding (RPF) state is installed in the sink. In other words, the identity of the anycast sinks one level below is recorded in soft state in a database maintained by each anycast sink. This information provides a reverse path to lower level sinks and ultimately to each AR in the HLA corresponding to the sink. The AV for each AR is sent to an arbitrary node N (for example, the FAR, the originating AR, or HA of the MN, or a paging server or SIP server). When paging or broadcasting to a MN is required, the node N, for example the FAR, may itself initiate a page or broadcast to a MN over a selected HLA by unicasting a paging or broadcasting request message to the anycast sink corresponding to the selected HLA. Alternatively, node N can unicast a paging or broadcasting request message first to the KAR which instructs the HLA page/broadcast on its behalf and returns the result to node N. On receiving the broadcast or paging request message, the sink multicasts the message to each of the lower level nodes in its RPF database. If these lower level nodes are anycast sinks themselves, then they in turn multicast the message to each of the lower level nodes in their RPF databases, and so on until the messages is multicast to all the ARs belonging to that HLA.

FIGS. 18a, 18b and 18c show how a broadcast or paging request message may be sent (dotted arrows 110, 112, and 114 respectively) from an arbitrary node N 46 to each of three different anycast sinks (116, 118, and 120 respectively) corresponding to three different HLAs. The broadcast or paging request message is then efficiently multicast (solid arrows 122, 124, and 126 respectively) to all the ARs belonging to the HLA corresponding to each anycast sink. The ARs then instruct their associated base stations to initiate paging or broadcasting to MNs over the radio interface (solid lines 128).

The method of using RPF state to page or broadcast to HLAs, however, ties the page/broadcast forwarding to sink distribution causing the messages to traverse routers high in the domain routing hierarchy and far away from the ARs they are trying to reach. According to another method, associated with each anycast sink at each level of the hierarchy is a unique multicast address. Thus, each HLA—i.e. each cluster of ARs—has a unique multicast address. ARs of the domain periodically send anycast datagrams according to the parallel or sequential models described above. This refreshes the composition of the HLAs in the event of any changes in the topology of the domain. If the parallel model is used, when an anycast sink receives an anycast datagram from an AR, it sends a unicast message including its unique multicast address back to the AR. If the sequential model is used, the multicast address is recorded in each successive datagram and upon receiving the final anycast datagram in respect of an originating AR, each top level sink sends a unicast datagram back to the AR containing the multicast addresses associated with each lower level sink through which the anycast datagrams were received and sent on behalf of that AR. Thus, in both the parallel and sequential models, each AR receives a plurality of multicast addresses corresponding to all the HLAs to which it belongs—i.e. one HLA at each level of the hierarchy per AR. The parallel model requires more messaging but it minimises dependence on the intermediate sinks. In addition, each level of the anycast hierarchy can be explored at different rates (faster for lower levels due to rate of movement of MNs and the desire to have accurate clusters).

Each AR joins the multicast groups corresponding to the HLAs to which it belongs and leaves any multicast groups corresponding to HLAs to which it no longer belongs (because of network topology changes, for example). ARs may also send a message to an arbitrary node N (for example, the FAR or KAR or any server performing a paging or locating service such as a SIP server or LCS), indicating the list of multicast addresses corresponding to the HLAs it is a member of. When a MN needs to be paged for or broadcast to in an HLA, the paging or broadcast request message is sent to the multicast address corresponding to the correct HLA, by the paging node, such as the KAR or the FAR etc, and is received by all the ARs which belong to that HLA. These ARs then instruct their associated base stations to page for or broadcast to the MN within their cells over the radio interfaces.

FIGS. 19a, 19b and 19c show how a broadcast or paging request message may be sent from a KAR to each of three different multicast addresses corresponding to three HLAs. The broadcast or paging request message is efficiently sent over the unicast topology (shown as solid arrows 102, 104 and 108 respectively) to all the ARs belonging to the HLA associated with the multicast addresses which then instruct their associated base stations to initiate paging or broadcasting to MNs over the radio interface (shown by solid lines 108). As with the LLLA-based approach to paging, when a series of expanding HLA-based pages are used, a mechanism is preferably employed to ensure that the same ARs are not searched twice so that the series of pages forms an expanding ring search. This may be achieved in a similar manner to what has been described above. According to the multicast group HLA embodiment, the KAR would page each AR in the domain only once by including in the paging request the previous multicast groups explored. This would be used by a modified multicast routing protocol to only forward the page to those interfaces in the present multicast group which are not members of the previously explored groups.

It will be appreciated that in the HLA-based paging approach described above, whether using multicast groups or RPF via anycast sinks, the paging node N may be an AR of the domain, for example the FAR. If the anycast hierarchy is structured such that there is a single anycast sink at the top level (and thus a top level HLA comprising all ARs), then there will always be at least one HLA (i.e. at least the top level HLA) in which both the FAR and the KAR are members. The closer the KAR and FAR are, the more HLAs they will have in common. The FAR will thus receive some information on the progress of HLA-based paging simply as a result of itself being an AR and potentially one of the ARs in the HLAs being used for paging.

It should be noted that the anycast routing protocol may be used, as described above, to cluster or partition any set of nodes of one or more domains intro groups for any purpose whatsoever. The parallel and serial exploration mechanisms and the reverse path forwarding and multicast forwarding mechanisms described above are generally applicable and may be used as a means to establish a data path to or to establish a data path between members of any group so defined or to inform members or other nodes of the clustering or partitioning for whatever reason. Furthermore, multiple sets of anycast sinks may be chosen in any manner (whether containing successively less members or not) and used to partition or cluster the set of nodes in various manners for whatever purpose.

Anycast routing is a form of dynamic routing and is therefore adaptive and self-healing. Thus, the present invention provides a distributed and resilient method for subdividing a routing topology into multiple areas that is robust with respect to link and router failures. FIGS. 20a, b and c illustrate how anycast routing reacts to failure of a node, for example. FIG. 20a shows a set of nodes of a data network represented by circles 130 and anycast routes over individual data links shown by arrows 132. Three of the nodes, represented by filled in circles 134, are anycast sinks. FIG. 20b shows the same set of nodes upon failure of the central anycast sink which is shown as dotted circle 136, and consequently the anycast routes to that sink, which are shown as dotted arrows 138. FIG. 20c shows how the anycast routes 132 may be automatically rearranged in reaction to the sink failure

Inter-Working of LLLA- and HLA-Based Paging

In general LLLA-based micro paging and HLA-based macro paging will be interworked. For example, LLLA-based paging will be used initially when a FAR needs to locate a MN in warm or cold state. Expanding ring searches may be used by paging for the MN in successive LLLAs of increasing radius around the KAR, while avoiding repeating paging by AR's that have already paged for the MN in previous LLLA-based pages. If LLLA-based paging fails, HLA-based paging originating from the KAR may be used. Again, expanding ring searches may be used by paging for the MN in successive HLAs of increasing size while avoiding repeating paging by AR's that have already paged for the MN in previous LLLA-based micro paging or in previous HLA-based macro paging.

According to one method for paging or broadcasting to an MN which inter-works HLA-based and LLLA-based approaches, and which adopts the parallel or sequential anycast datagrams model described above, periodically, but not necessarily in synchronism with each other, each AR in the domain (i.e. every possible KAR) sends the appropriate anycast datagrams according to its model. This refreshes the clustering in the event of any topology change in the network as before. The HLA memberships of each AR (i.e. the identities of the anycast sinks or multicast groups associated with the anycast sinks) is then broadcast to the MNs at each AR over the air. When a MN changes LLLA, it or the KAR forwards the new KAR address to the FAR in a LLLA LU, and includes the HLA membership of the new KAR, so that the FAR knows both the KAR for LLLA-based paging and the HLA membership for HLA-based paging.

When a FAR wishes to page a MN, it contacts the KAR which undertakes micro LLLA-based paging. If this fails, the KAR moves into macro paging and sends the page to the most locally scoped HLA multicast group which contacts ARs across multiple adjacent LLLAs around the present LLLA (in which the micro page failed). It then repeats this in turn to each of the broader scoped multicast groups (more ARs dispersed even further from the KAR) until the MN is found at which point the MN or the PAR contacts the KAR which contacts the FAR. Thus, the FAR knows both the KAR for LLLA-based paging (as a result of the LLLA LU from the KAR) and the HLA membership for HLA-based paging.

According to another method for paging or broadcasting to an MN which inter-works HLA-based and LLLA-based approaches, and which adopts the parallel or sequential anycast datagrams model described above, every time a MN changes LLLA, this triggers the new KAR to explore the anycast hierarchy by sending the appropriate anycast datagrams according to its model. This refreshes the clustering in the event of any topology change in the network as before. The HLA memberships of the KAR (i.e. the identities of the anycast sinks or multicast groups associated with the anycast sinks) are then send directly to the FAR by the anycast sink or sinks. Paging may then take place using the interworked LLLA and HLA approaches as described above.

According to another method for paging or broadcasting to an MN which inter-works HLA-based and LLLA-based methods, and which adopts the sequential anycast datagrams model described above, periodically, but not necessarily in synchronism with each other, each AR in the domain (i.e. every possible KAR) sends an anycast datagram up the hierarchy to the top. This refreshes the clustering in the event of any topology change in the network as before. The clusters of ARs belonging to each sink are stored in each sink all the way up to the top. However, no AV is created. In parallel, each time a MN changes LLLA it triggers a new LU to the FAR and an anycast datagram from its new KAR.

Included in this refresh message is the address of the KAR of the MN as well as an identifier for the MN, such as its CCoA. However, this MN-triggered anycast message only goes up as far as the first anycast sink which has the old KAR in its cluster list (i.e. an intersecting sink). At this sink, an entry for the MN is created 5 which includes the centre AR of the LLLA for LLLA-based paging. Also an AV (only as far as this intersecting sink) is stored at the intersecting sink. When the FAR needs to page the MN a paging message is sent up the anycast hierarchy as far as the sink which has the MN entry and then LLLA-based paging can be initiated for the MN (or if that fails anycast paging using the centre AR of the 10 LLLA). If there has been a topology change and the paging message never finds a sink with the MN entry (i.e. because it has failed) then the paging message goes to the top and a domain wide page occurs.

Results of Paging

It will be understood from the above that paging, whether using the 1 5 LLLA-based mechanism, the HLA-based mechanism or inter-working the two, may be initiated by any arbitrary node which performs a paging service such as a FAR, SIP server or a LCS and that the results of paging (either a successful location of the MN or failure) used for any purpose whatsoever. In general, the results of paging will be notified to the node performing the paging service by means of a unicast paging acknowledgement message, for example, from the PAR if the page was successful, or from the KAR or an anycast sink if unsuccessful. If paging is successful, the paging acknowledgement message could be multicast back to the paging node by the PAR on the same HLA or LLLA in which the MN was discovered, to truncate page processing on other ARs in the same group, and for those ARs to update movement, statistics etc.

When paging is initiated by the FAR according to the general mobility model described above, then, if paging is successful, the PAR or the MN should send a paging acknowledgement message to the FAR or the existing KAR indicating success of the page and the identity of the PAR—i.e. where the MN actually is now. If the message is sent to the KAR, then the KAR should forward it to the FAR. The KAR or FAR may accumulate statistics. Sending the message from the MN may be faster and more efficient than from the PAR but the PAR is trusted in this system, since it is a network router whereas the MN is a user device and needs a security association with the KAR or FAR.

For an MN in any pageable state (i.e. active, hot, warm or cold) a successful page will result in the MN or KAR sending an intra-domain LU to the FAR which updates the KAR entry recorded in the FAR, and thereby re-centring the MN in a new LLLA. Where the FAR needs to send a data packet to an MN in warm or cold state and which has moved away from the FAR, a successful page will result in the further activity as follows. For an MN in cold state, the PAR, provides the MN with a CCoA from its pool of local IP addresses. An EMA hand-off request is sent from the PAR back to the FAR (its RAR), causing host-specific route injection and hence causing the FAR function to now reside at the PAR by definition. The PAR also performs an inter-domain LU to update the HA of the MN with the new FAR. Thus, the PAR becomes the AAR, the new FAR and the KAR of the MN. The MN then enters active state an is ready to receive the data packet. The process is similar for a MN in warm state, except that it already has a CCoA from the FAR—its AAR.

It will be understood that while the detailed description of the present invention has assumed that an EMA/MER protocol is used for intra-domain routing and MIP v.4 or MIP v.6 for inter-domain routing, the approaches to monitoring the location and to paging for or broadcasting to MNs are applicable to any mobile routing protocol or combination of mobile routing protocols. For example, the present invention may be used in MIP v.4 or MIP v.6, Cellular IP, or HAWAII and combinations thereof.

When a mobile node is actively transmitting [i.e. not in idle mode] the LLLA or HLA represents which AR[s] the mobile is likely to move onto next. In other embodiments this information can be used to speed up the eventual handover of the MN between ARs by taking ‘useful action’ in advance. Examples of such action might include authorizing/authenticating the MN at potential new AR[s], reserving capacity at the potential new AR[s] (to ensure better quality of service if/when the ‘call’ does handover), downgrading the priority given to existing calls on the potential new AR[s], increasing the odds of blocking new call attempts at the potential new AR[s], transferring ‘context’ to the potential new AR[s] (examples of context are header compression state, multicast group membership and IPsec state), setting up a temporary tunnel between the old AR and the potential new AR.

1. A method of operating a communications network to determine membership of a group of access nodes of the communications network with which there is a relatively high probability that a mobile node will be associated after the mobile node has been associated with a first access node, access nodes being linked to other access nodes via data communications links, the method comprising:
a) detecting characteristics of relationships between access nodes;
b) operating said communications network to determine membership of the group in dependence on the detected characteristics.

2. A method according to claim 1, wherein the detecting involves the first access node receiving one or more messages, said messages being transmitted from said other access nodes, said messages identifying one or more of said other access nodes.

3. A method according to any preceding claim, wherein the characteristics comprise the number of direct communications links between access nodes.

4. A method according to claim 1 or claim 2, wherein the characteristics comprise the number of tunnel communications links between access nodes.

5. A method according to claim 3 or 4, wherein the determining of membership of the group involves comparing the number of direct or tunnel communications links to a predetermined number:

6. A method according to claim 5, wherein the predetermined number may vary in dependence on a parameter or the identity of the first access node.

7. A method according to any preceding claim, wherein the communications network is capable of handing over a mobile node between said other access nodes, and wherein the detecting involves monitoring handovers of mobile nodes to access nodes other than the first access node, the handovers including handovers from the first access node to a first other access node.

8. A method according to claim 7, wherein the handovers include handovers from said first other access node to a second other access node.

9. A method according to any of claims 7 to 8, wherein the characteristics comprise a probability of a mobile node being involved in a handover between access nodes.

10. A method according to any preceding claim, wherein the group is for paging for or broadcasting to a mobile node.

11. A method according to any preceding claim, wherein the group is for monitoring the location of a mobile node.

12. A method according to any preceding claim, wherein the group is used for the optimisation, support or initiation of handover of a mobile node between access nodes.

13. A method of paging for or broadcasting to a mobile node of a communications network comprising access nodes being linked to other access nodes via data communications links, the method comprising sending a data message to one or more nodes of a group of access nodes, wherein the membership of said group is determined in accordance with the method of any of claims 1 to 12.

14. A computer program for performing the method of any preceding claim.

15. Apparatus adapted to perform the method of any preceding method claim.

16. A method of operating a communications network to determine membership of one or more groups of access nodes of said communications network associated with a first access node, the method comprising:
a) arranging for the first access node to receive messages from n-hop access nodes, wherein said n-hop access nodes are n-hops from said first access node;
b) the first access node receiving from said n-hop access nodes a first set of one or more messages, wherein said first set of messages identify one or more (n+1)-hop access nodes, wherein said (n+1)-hop access nodes are one hop from said n-hop access node sending the message;
c) arranging for the first access node to receive messages from said (n+1)-hop access nodes identified in the first set of one or more messages;
d) the first node receiving from said (n+1)-hop access nodes a second set of one or more messages, wherein said second set of messages identify one or more (n+2)-hop access nodes, wherein said (n+2)-hop access nodes are one hop from said (n+1)-hop access node sending the message;
e) operating said communications network to determine membership of said one or more groups such that all members of a group are exclusively either n-hop, (n+1)-hop or (n+2)-hop access nodes.

17. A method of operating a communications network to determine membership of a group of access nodes of the communications network with which there is a relatively high probability that a mobile node will have a wireless link after the mobile node has had a wireless link with a first access node, the communications network being capable of handing over a mobile node between access nodes thereby establishing a new wireless link, the method comprising:
a) monitoring handovers of mobile nodes to access nodes other than the first access node, the handovers including handovers from the first access node to first other access nodes; and
b) operating the communications network to determine membership of the group such that access nodes involved in monitored handovers are members of said group.

18. A method according to claim 17 wherein the handovers include handovers from said first other access nodes to a second other access node.
